(19) United States
(12) Patent Application Publication
(10) Pub. No.: US 2026/0180231 A1
(43) Pub. Date: Jun. 25, 2026

(54) CONNECTOR ASSEMBLY

(71) Applicant: Molex, LLC, Lisle, IL (US)

(72) Inventor: Takahiro Nishida, Yamato (JP)

(21) Appl. No.: 19/429,060

(22) Filed: Dec. 22, 2025

(30) Foreign Application Priority Data
Dec. 24, 2024 (JP) 2024-227686

(51) Int. Cl. H01R 13/504; H01R 12/70; H01R 12/71; H01R 13/24

(52) U.S. Cl. CPC H01R 13/5045; H01R 12/707; H01R 12/7082; H01R 12/716; H01R 13/24

(57) ABSTRACT

A connector assembly is provided to facilitate manufacturing, enable miniaturization and low height, and increase reliability. The assembly includes a receptacle connector and a plug connector that mates therewith. The receptacle connector includes a receptacle housing and receptacle terminals attached thereto. The receptacle housing includes a housing wall part positioned between a press-fit part and a contact part of the receptacle terminal. The plug connector includes a plug housing and plug terminals attached thereto. The plug housing includes a flange formed on at least an outer edge in the area where the plug terminals are mounted. When the receptacle connector and the plug connector are in a mated state, an area exceeding half of an upper surface of the flange abuts against the upper wall surface of the housing wall part of the receptacle housing.

### TECHNICAL FIELD

The present disclosure relates to a connector assembly.

### DESCRIPTION OF RELATED ART

Conventionally, connector assemblies such as board-to-board connectors have been used to electrically connect pairs of parallel circuit boards to each other. In this manner of connector assembly, connectors attached to opposing surfaces of a pair of circuit boards are mated together to establish electrical continuity (see, for example, Patent Document 1).

FIG. 32 is a cross-sectional view depicting a conventional connector assembly.

In the drawing, 811 is a connector housing mounted on a first circuit board (not depicted), which has a pair of convex protrusions 812 extending in the longitudinal direction thereof. Furthermore, a plurality of terminals 861 are mounted to the protrusions 812 side-by-side in the longitudinal direction of the connector. Each terminal 861 includes a board connection part 862 that is connected to the circuit board, and a contact part 863 that comes into contact with a counterpart terminals 961 of a counterpart connector.

In addition, reference numeral 911 denotes a counterpart housing of a counterpart connector to be mounted on a second circuit board (not depicted), and has a pair of elongated recessed grooves 912 extending in the longitudinal direction. A plurality of counterpart terminals 961 are attached to the recessed groove 912 in a line in the longitudinal direction of the connector. Each counterpart terminal 961 includes a counterpart board connection part 962 that is connected to the circuit board, and a counterpart contact part 963 that comes into contact with a terminal 861 of the connector.

When the connector and the counterpart connector are mated, each of the protrusions 812 of the housing 811 are inserted into the corresponding recessed groove 912 of the counterpart housing 911. On the other hand, an intermediate land 913 formed between the left and right recessed grooves 912 in the counterpart housing 911 is inserted into a recessed groove part 813 formed between the left and right protrusions 812 in the housing 811. As depicted in the figure, when the connector and the counterpart connector are mated completely, the top surface of the intermediate land 913 abuts against the surface of a bottom plate 814 of the housing 811 that closes the bottom of the recessed groove part 813, in other words, against the bottom surface of the recessed groove part 813. This positions the connector and the counterpart connector in terms of the mating direction, and stabilizes the relative positional relationship and orientation between the connector and the counterpart connector once mating is complete. As a result, the contact state between the contact part 863 of the corresponding terminal 861 and the counterpart contact part 963 of the counterpart terminals 961 becomes stable, and the conductive state between the corresponding terminal 861 and the counterpart terminals 961 becomes stable.

### SUMMARY

However, the conventional connector assemblies described above are unable to adequately accommodate the trend toward smaller and thinner members in recent electronic devices.

In recent years, electronic devices such as laptop computers, tablets, smartphones, digital cameras, music players, game consoles, and navigation devices have required smaller and lower-profile cases, and therefore smaller and lower-profile components, which has led to a demand for even smaller and lower-profile connector assemblies.

However, in the case of the conventional connector assembly, if the width or height is reduced to further reduce the size and height, stability during mating cannot be maintained, and the connector and/or counterpart connector may be damaged or tilted, which may reduce the reliability of the mating.

An object of the present disclosure is to provide a connector assembly which overcomes the aforementioned problems of the conventional technology, is easy to manufacture, can be made compact and thin, and is highly reliable.

To this end, the connector assembly is a connector assembly including a receptacle connector and a plug connector that mates with the receptacle connector; wherein the receptacle connector includes a receptacle housing and a receptacle terminal attached to the receptacle housing, the receptacle housing including a housing wall part positioned between the press-fit part and the contact part of the receptacle terminal, the plug connector including a plug housing and a plug terminal attached to the plug housing, the plug housing including a flange formed on at least a first outer edge in the area where the plug terminal is mounted, and when the receptacle connector and plug connector are in a mated state, an area exceeding half of the upper surface of the flange may abut against the upper wall surface of at least a first housing wall part of the receptacle housing.

In another connector assembly, when the receptacle connector and the plug connector are in a mated state, more than half of the upper surface of the flange may abut against the upper wall surfaces of both housing wall parts of the receptacle housing.

In still another connector assembly, the contact part of the receptacle terminal includes a first arm part, a second arm part, and a connecting part connecting the first arm part and the second arm part, and has an overall approximately U-shaped configuration, and the upper wall surface of the housing wall part is formed to an area that covers a part of the upper part of the second arm part positioned on the press-fit part side of the receptacle terminal.

In still another connector assembly, a board connection part is further formed at the lower end of the press-fit part of the receptacle terminal.

In yet another connector assembly, the receptacle terminal further includes a second connecting part that connects the press-fit part and the second arm part, and the lower end of the housing wall part faces the second connecting part with a gap therebetween.

In still another connector assembly, the upper surface of the flange of the plug housing further includes an inner column lower cover part that covers at least a part of the lower end of the inner column part of the plug terminal.

According to the present disclosure, the connector assembly is easy to manufacture, can be made smaller and thinner, and has improved reliability.

### BRIEF DESCRIPTION OF THE DRAWINGS

FIG. 1 is a perspective view of a connector assembly according to Embodiment 1, as viewed from a first connector side;

FIGS. 2A and 2B are perspective views of the first connector according to Embodiment 1, where FIG. 2A is a perspective view when viewed from a mating surface, and FIG. 2B is a perspective view when viewed from a mounting surface;

FIG. 3 is an exploded perspective view of the first connector according to Embodiment 1;

FIG. 4 is a perspective view depicting a state in which a metal member and an insulating member of the first connector according to Embodiment 1 are separated;

FIGS. 5A, 5B, 5C and 5D show a four-plane diagram of the first connector according to Embodiment 1, where FIG. 5A is a front view, FIG. 5B is a top view, FIG. 5C is a side view, and FIG. 5D is a bottom view;

FIGS. 6A and 6B are perspective views of a second connector according to Embodiment 1, where FIG. 6A is a perspective view when viewed from a mating surface, and FIG. 6B is a perspective view when viewed from a mounting surface;

FIG. 7 is an exploded perspective view of the second connector according to Embodiment 1;

FIGS. 8A, 8B, 8C and 8D show a four-plane diagram of the second connector according to Embodiment 1, where FIG. 8A is a front view, FIG. 8B is a top view, FIG. 8C is a side view, and FIG. 8D is a bottom view;

FIGS. 9A, 9B and 9C show a first three-plane diagram depicting the first connector and second connector according to Embodiment 1 in a mated state where FIG. 9A is a plan view of the first connector as viewed from the side, FIG. 9B is a cross-sectional view along line A-A in FIG. 9A, and FIG. 9C is a cross-sectional view along line B-B in FIG. 9A;

FIGS. 10A and 10B show a second three-plane diagram depicting the first connector and the second connector according to Embodiment 1 in a mated state, in which FIG. 10A is a plan view as viewed from the first connector side, FIG. 10B is a perspective view of the second connector along line C-C in FIG. 10A, and FIG. 10C is a perspective view of the first connector including a cross section along line C-C in FIG. 10A;

FIGS. 11A, 11B, 11C and 11D show first transverse cross-sectional views of the first connector and the second connector according to Embodiment 1 in a mated state, where FIG. 11A is a cross-sectional view of the second connector along line D-D in FIG. 10A, and FIG. 11B is a cross-sectional view of the first connector along line D-D in FIG. 10A;

FIGS. 12A and 12B show second transverse cross-sectional views of the first connector and the second connector according to Embodiment 1 in a mated state, where FIG. 12A is a cross-sectional view of the second connector along line E-E in FIG. 10A, and FIG. 12B is a cross-sectional view of the first connector along line E-E in FIG. 10A;

FIGS. 13A, 13B and 13C show longitudinal cross-sectional views of the first connector and the second connector according to Embodiment 1 in a mated state, where FIG. 13A is a cross-sectional view along line F-F in FIG. 10A, FIG. 13B is a cross-sectional view of the second connector along line F-F in FIG. 10A, and FIG. 13C is a cross-sectional view of the first connector along line F-F in FIG. 10A;

FIGS. 14A, 14B, 14C and 14D show a two-plane diagram depicting the first connector and the second connector according to Embodiment 1 in a mated state, where FIG. 14A is a side view and FIG. 14B is a cross-sectional view along line G-G in FIG. 14A;

FIG. 15 is an enlarged cross-sectional view of the first connector and the second connector according to Embodiment 1 in a mated state, and is an enlarged view of part H in FIG. 14B;

FIGS. 16A and 16B show a two-plane diagram depicting a case where the relative positions of the first connector and the second connector in a mated state according to Embodiment 1 are offset, where FIG. 16A is a side view and FIG. 16B is a cross-sectional view along line J-J in FIG. 16A;

FIG. 17 is an enlarged cross-sectional view of a case where the relative positions of the first connector and the second connector in the mated state according to Embodiment 1 are offset, and is an enlarged view of part K in FIG. 16B;

FIGS. 18A and 18B show a two-plane diagram depicting the first connector and the second connector according to a reference example in a mated state, where FIG. 18A is a side view and FIG. 18B is a cross-sectional view along line L-L in FIG. 18A;

FIG. 19 is an enlarged cross-sectional view of the first connector and the second connector in the reference example in a mated state, and is an enlarged view of part M in FIG. 18B;

FIG. 20 is a cross-sectional view depicting a case where the relative positions of the first connector and the second connector in a mated state according to the reference example are offset, and is a cross-sectional view corresponding to the cross section along line L-L in FIG. 18A;

FIG. 21 is an enlarged cross-sectional view in which the relative positions of the first connector and the second connector in a mated state according to the reference example are offset, and is an enlarged view of part N in FIG. 20;

FIGS. 22A, 22B and 22C show a first three-plane diagram depicting the first connector and second connector of Embodiment 2 in a mated state where FIG. 22A is a plan view of the first connector as viewed from the side, FIG. 22B is a cross-sectional view along line P-P in FIG. 22A, and FIG. 22C is a cross-sectional view along line Q-Q in FIG. 22A;

FIGS. 23A, 23B and 23C show a second three-plane diagram of the first connector and the second connector according to Embodiment 2 in a mated state, in which FIG. 23A is a plan view of the first connector from the side, FIG. 23B is an perspective view of the second connector including a cross section along line R-R in FIG. 23A, and FIG. 23C is a perspective view of the first connector including a cross section along line R-R in FIG. 23A;

FIGS. 24A and 24B show first transverse cross-sectional views of the first connector and the second connector according to Embodiment 2 in a mated state, where FIG. 24A is a cross-sectional view of the first connector along line S-S in FIG. 23A, and FIG. 24B is a cross-sectional view of the second connector along line S-S in FIG. 23A;

FIGS. 25A and 25B show second transverse cross-sectional views of the first connector and the second connector according to Embodiment 2 in a mated state, where FIG. 25A is a cross-sectional view of the first connector along line T-T in FIG. 23A, and FIG. 25B is a cross-sectional view of the second connector along line T-T in FIG. 23A;

FIG. 26 is a perspective view of the first connector according to Embodiment 3;

FIG. 27 is a perspective view of the second connector according to Embodiment 3;

FIGS. 28A and 29B show a two-plane diagram depicting the first connector and the second connector according to Embodiment 3 in a mated state, where FIG. 28A is a side view and FIG. 28B is a cross-sectional view along line U-U in FIG. 28A;

FIG. 29 is an enlarged cross-sectional view of the first connector and the second connector according to Embodiment 3 in a mated state, and is an enlarged view of part V in FIG. 28B;

FIG. 30 is a cross-sectional view depicting a case where the relative positions of the first connector and the second connector in a mated state according to Embodiment 3 are offset, and is a cross-sectional view corresponding to the cross section along U-U in FIG. 28A;

FIG. 31 is an enlarged cross-sectional view of a case where the relative positions of the first connector and the second connector in the mated state according to Embodiment 3 are offset, and is an enlarged view of part W in FIG. 30; and

FIG. 32 is a cross-sectional view depicting a conventional connector assembly.

### DETAILED DESCRIPTION

Embodiments will hereinafter be described in detail with reference to the drawings.

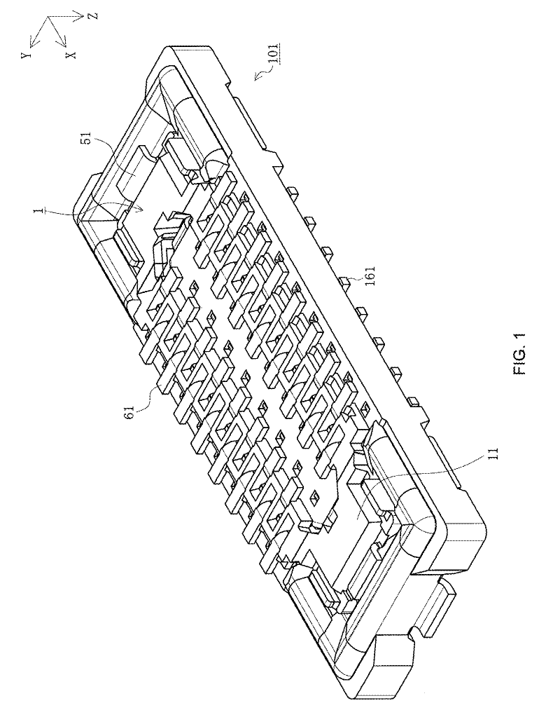

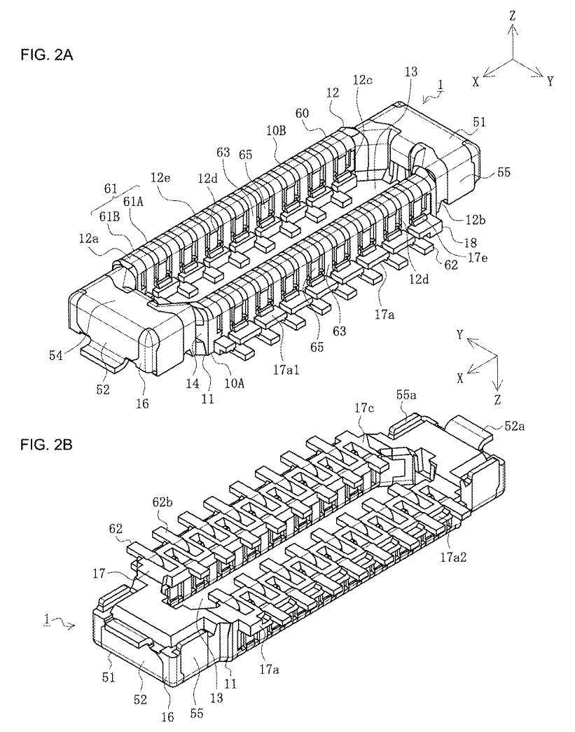

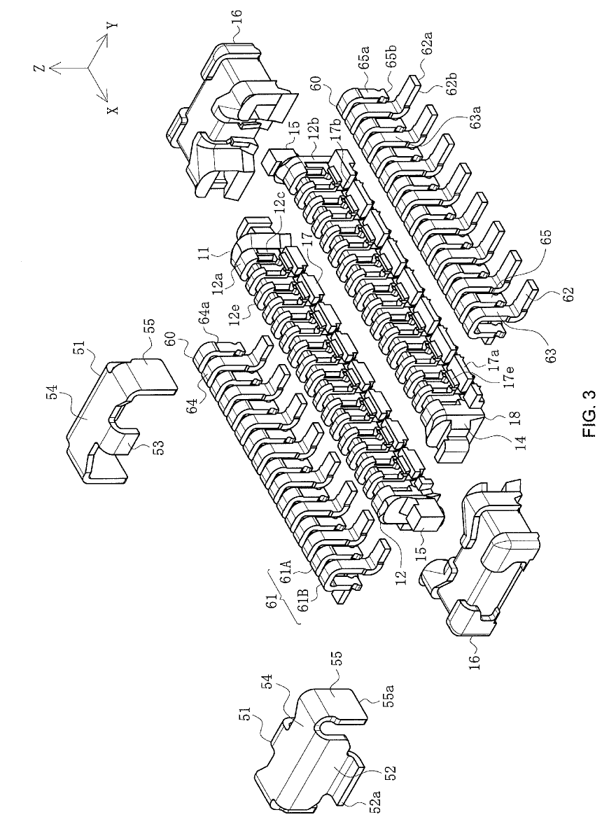

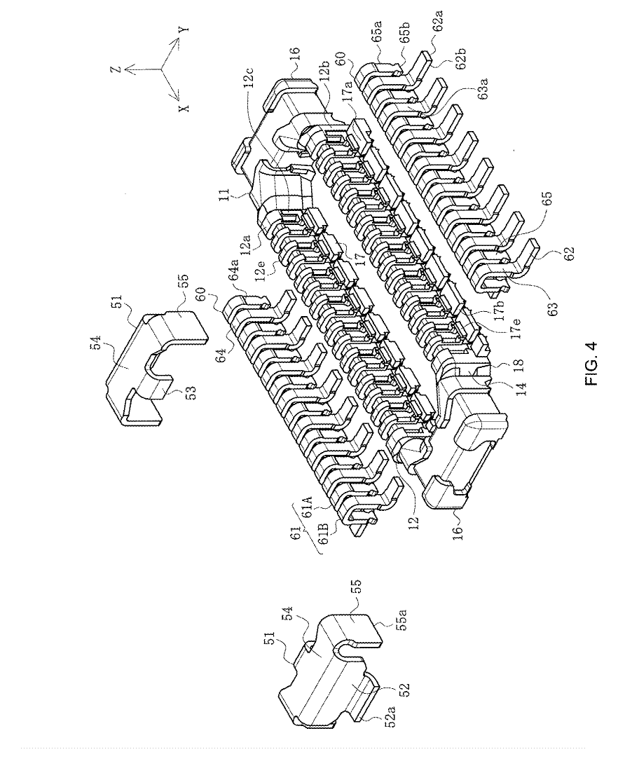

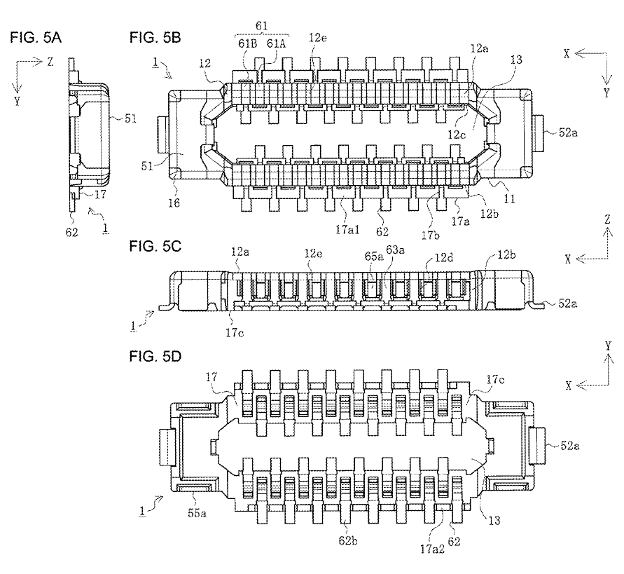

FIG. 1 is a perspective view of a connector assembly according to Embodiment 1, as viewed from the first connector side. FIG. 2 is a perspective view of the first connector according to Embodiment 1. FIG. 3 is an exploded perspective view of the first connector according to Embodiment 1. FIG. 4 is a perspective view depicting a state in which a metal member and an insulating member of the first connector according to Embodiment 1 are separated. FIG. 5 is a four-plane diagram of the first connector according to Embodiment 1. Note that FIG. 2A is a view from the mating surface side, and FIG. 5B is a view from the mounting surface side. FIG. 5A is a front view, FIG. 5B is a top view, FIG. 5C is a side view, and FIG. 5D is a bottom view.

In the drawings, reference numeral 1 denotes a connector in the present embodiment, which is a first connector serving as a first connector of a pair of board-to-board connectors. The first connector 1 is a surface-mount type plug connector that is mounted on a surface of a first board, which is a board (not depicted) serving as a mounting member and has a generally rectangular planar shape and is mated with a second connector 101 serving as a counterpart connector. In addition, the second connector 101 is a second connector of the pair of board-to-board connectors and is a surface-mount type receptacle connector mounted on a surface of a second board (not depicted) serving as a mounting member. Note that the first connector 1 and the second connector 101 are counterpart connectors in a pair of board-to-board connectors.

Furthermore, the first connector 1 and the second connector 101 constitute a connector pair or a connector assembly.

It should be noted that the first connector 1 and the second connector 101 according to the present embodiment are preferably used to electrically connect a first board to a second board, but may also be used to electrically connect other members. For example, the first board and the second board are each a printed circuit board, a flexible flat cable (FFC), a flexible circuit board (FPC), or the like as used in electronic devices or the like, but may be any type of board.

In addition, in the present embodiment, expressions indicating direction such as top, bottom, left, right, front, rear, and the like used to describe the configuration and operation of each part of the first connector 1 and the second connector 101 are relative rather than absolute and are appropriate when each part of the first connector 1 and the second connector 101 are in the positions depicted in the drawings; that said, these directions should be interpreted as changing in accordance with the change in position when the position thereof is changed.

Furthermore, for example, the first connector 1 has dimensions of a length (size in the X-axis direction) of about 6.0 mm, a width (size in the Y-axis direction) of about 2.0 mm, and a height (size in the Z-axis direction) of about 0.5 mm. However, the dimensions may be changed as appropriate.

In addition, the first connector 1 is composed of a pair of right and left half body parts, or a left half body part 10A and a right half body part 10B, joined by a first reinforcement fitting 51 as a reinforcement fitting, or in other words a nail, and a first protruding end part 16 as a cover part that is integrally molded by a method of molding called over-molding, outsert molding, or insert molding (hereinafter, referred to as “insert molding”). Note that as the left half body part 10A and the right half body part 10B are the same members arranged so as to face each other on the left and right sides, they will be described as half body part 10 when comprehensively described. The left half body part 10A and the right half body part 10B are each substantially gate shaped (a shape projected on the X-Y plane) in a plan view, with the space between the left half body part 10A and the right half body part 10B that are joined together being a long and narrow recessed groove part 13 extending in the longitudinal direction (X-axis direction) of the first connector 1. The recessed groove part 13 is a through hole that is open on the upper surface and the lower surface of the first connector 1.

Note that in the present embodiment, for convenience of description, the first connector 1 is described as having first and second half body parts 10, that is, a configuration in which two of the half body parts 10 are arranged in parallel; however, three or more of the half body parts 10 may be arranged in parallel. Furthermore, the half body part 10 does not necessarily need to be substantially gate shaped and may have any shape provided that both ends in the longitudinal direction may be joined by the first reinforcement fitting 51 and the first protruding end part 16.

Furthermore, in the present embodiment, the recessed groove part 13 is described as one through-hole; but may be a hole with a bottom having a bottom plate. Even if the connector has a bottom like conventional connectors, it is easy to conceive that the reliability of mating and connection will decrease due to the narrower width and lower height. In addition, the bottom plate may have a plurality of through-holes and in this case, the through-holes are desirably set to at least enable visually confirming a tail part 62 of the first terminals 61 positioned in the recessed groove part 13. Thus, the appearance and the like of the connected state of the tail part 62 and the board by soldering or the like can easily be confirmed from the outside.

The first connector 1 has a first housing 11 which is integrally formed from an insulating material such as synthetic resin or the like and has a generally gate-like shape in plan view as the plug housing that is the housing. The first housing 11 has a pair of side wall parts 18 extending in the longitudinal direction (X-axis direction), the side wall parts 18 are parallel to each other, and both ends of the side wall parts 18 are connected by a pair of first protruding end parts 16. It should be noted that the pair of first protruding end parts 16 may also be referred to as a pair of end walls of the first connector 1. Each side wall part 18 includes an elongated strip-shaped bottom plate part 17 extending in the longitudinal direction (X-axis direction) of the first housing 11, and a first protrusion 12 as a convex wall which is an elongated protrusion extending in the longitudinal direction of the first housing 11 and integrally formed on the upper surface of the bottom plate part 17. In other words, the side wall parts 18 include a bottom plate part 17 and a first protrusion 12 as a convex wall protruding from the bottom plate part 17 in the mating direction (Z-axis positive direction). The pair of first protrusions 12 face each other and are parallel to each other, and the pair of first protruding end parts 16 also face each other and are parallel to each other.

The first protrusion 12 is a member having a roughly arch-shaped cross section, is positioned on the upper side (Z-axis positive direction side), and has a mating surface 12a, which is an upper surface facing upward, and an outer surface 12b and inner surface 12c connected to both the left and right sides of the mating surface 12a. The outer surface 12b is a surface facing outward in the width direction (Y-axis direction) of the first housing 11 and the inner surface 12c is a surface facing inward, toward the recessed groove part 13, in the width direction of the first housing 11. Furthermore, the outer surface 12b and the inner surface 12c are a pair of flat surfaces that face each other in parallel and extend in the longitudinal direction of the first housing 11.

In addition, the first terminals 61 are terminals disposed on each first protrusion 12. The first terminal 61 is a terminal of the first connector 1, which is a plug connector, and is therefore sometimes referred to as a plug terminal. Furthermore, the first terminals 61 are arranged at a prescribed pitch and in plural numbers. The first terminal 61 is a member integrally formed by carrying out processing such as punching and bending on a conductive metal plate. It should be noted that the first housing 11 is integrally formed with the first terminals 61 by insert molding. In other words, the first housing 11 is molded by setting the first terminals 61 inside and then filling in the cavity of the metal mold with an insulating material. Therefore, the first terminals 61 do not exist separated from the first housing 11, or in other words, the shape depicted in FIGS. 3 and 4 and the like where the location of the first terminals 61 mounted in the first housing 11 in a state where the first terminals 61 are separated does not exist. It should be noted that the depictions in FIGS. 3 and 4 and the like are solely for the convenience of description. Furthermore, similarly, the first reinforcement fitting 51 is not spaced apart from the first protruding end part 16, and the location where the first reinforcement fitting 51 is attached to the first protruding end part 16 is not spaced apart from the first reinforcement fitting 51 and does not have the shape depicted in FIGS. 3 and 4 and the like. It should be noted that the depictions in FIGS. 3 and 4 and the like are solely for the convenience of description.

In the present embodiment, there are a plurality of first terminals 61, which are attached to and supported by the first protrusion 12 of the side wall part 18, forming a plurality of terminal rows 60 (two in the example depicted in the figure), which are rows extending in the longitudinal direction of the first connector 1. In the first housing 11, a plurality (two in the example depicted in the figure) of side wall parts 18 are connected to the first protruding end part 16 and integrally connected, so it can be said that a plurality of terminal rows 60 are also retained by the first protrusion 12 of the first housing 11 and integrally connected.

In addition, the first terminals 61 include a first type of terminal first terminals 61A and a second type of terminal first terminals 61B. Furthermore, in each terminal row 60, the first terminals 61A and the first terminals 61B are arranged alternately. In addition, a first terminal row 60 and an adjacent second terminal row 60 are arranged so that the first terminals 61A and the first terminals 61B are lined up in the width direction (Y-axis direction) of the first connector 1. Note that in the example depicted in the figures, eight first terminals 61A and eight first terminals 61B are arranged at a prescribed pitch (for example, approximately 0.15 to 0.18 [mm]) in each of the terminal rows 60, but the number and pitch of the first terminals 61 in each of the terminal rows 60 may be changed as appropriate.

Note that the first protrusion 12 has a recessed part 12d formed in the inter-terminal wall 12e between adjacent first terminals 61 in the terminal row 60, in other words, between adjacent first terminal 61A and first terminal 61B, which is indented toward the center of the first protrusion 12 in the thickness direction (Y-axis direction). The recessed part 12d is formed on both the outer surface 12b and the inner surface 12c, which are the wall surfaces of the first protrusion 12, and in the inter-terminal wall 12e between the adjacent first terminals 61A and first terminals 61B. Because the recessed part 12d is formed, the wall surfaces of the outer surface 12b and inner surface 12c of the inter-terminal wall 12e, which is the portion that maintains insulation between adjacent first terminals 61 in the terminal row 60, become curved surfaces, and the distance between the first terminals 61 along the wall surface, in other words, the creepage distance, becomes longer compared to when the wall surface is flat, thereby improving the insulation between mutually adjacent first terminals 61.

In addition, the bottom plate part 17 is positioned on the lower side and protrudes outward in the width direction of the first housing 11 beyond the outer surface 12b, and protrudes inward in the width direction of the first housing 11 beyond the inner surface 12c. Furthermore, a flange 17a is formed on the outer surface 12b side of the bottom plate part 17 as a flat plate-shaped flange part that protrudes significantly outward in the width direction of the first housing 11. In other words, a flange 17a is formed on at least a first outer edge of the first housing 11 in the side wall part 18, which is the area where the first terminal 61, which is a plug terminal in the first connector 1, is mounted (in the example depicted in the figure, the outer edge on the outer surface 12b side of the bottom plate part 17). Note that if necessary, a flange 17a may also be formed on the outer edge of the bottom plate part 17 on the inner surface 12c side. In addition, a lower surface 17a2 (surface on the mounting surface side) of the flange 17a may be flush with a lower surface 17c of the bottom plate part 17, and whether or not flush with the lower surface 17c of the bottom plate part 17 may be selected as appropriate.

Furthermore, the flange 17a preferably includes an anchor cover part 17e as an inner column lower cover formed on an upper surface 17a1 (surface on the mating surface side) thereof. The anchor cover part 17e is formed to cover at least a part of the widthwise outer surface of the first protrusion 12 at the lower end of an inner column part 65 of the first terminal 61 and/or an anchor part 65b formed at said lower end. By forming the anchor cover part 17e, the strength of the flange 17a is improved, and the lower end of the inner column part 65 and/or the anchor part 65b are securely retained and protected by the first housing 11.

Since the flange 17a is formed so as to be positioned above (Z-axis positive direction) the lower surface 17c of the bottom plate part 17, the lower surface 17a2 of the flange 17a is positioned above (Z-axis positive direction) the lower surface 17c of the bottom plate part 17, which is the bottom surface of the first housing 11. The flange 17a has an upper surface 17a1 formed to be flat. Note that the lower surface 17c of the bottom plate part 17 is a mounting surface of the first housing 11 facing the surface of the first board.

The first terminal 61 is a member integrally formed by carrying out processing such as punching and bending on a conductive metal plate. It should be noted that the first terminals 61A and first terminals 61B are substantially identical, but are arranged so as to face in opposite left and right directions when viewed from the longitudinal direction (X-axis direction) of the first connector 1.

Furthermore, the first terminals 61 include an outer column part 63 as a second contact part extending in the vertical direction (Z-axis direction), a tail part 62 as a board connection part that protrudes from the lower end of the outer column part 63 toward the widthwise outer direction of the first protrusion 12, an inner column part 65 as a first contact part extending in the vertical direction opposite the outer column part 63, and a bent connecting part 64 that connects the upper end of the inner column part 65 to the upper end of the outer column part 63.

The widthwise outer surface of the first protrusion 12 in the outer column part 63 is a second contact surface 63a that functions as a contact surface that contacts a second terminal 161 of the second connector 101, and the widthwise outer surface of the first protrusion 12 in the inner column part 65 is a first contact surface 65a that functions as a contact surface that contacts the second terminal 161 of the second connector 101. An anchor part 65b having an anchor shape that is embedded in the bottom plate part 17 of the side wall part 18 and does not come out is formed at the lower end of the inner column part 65. Furthermore, an upper end protrusion 64a is formed so as to protrude outward in the width direction of the first protrusion 12 at the boundary between the upper end of the inner column part 65 and the connecting part 64.

Furthermore, an end surface 62a at the tip end of the tail part 62 is a cut surface that is generated when the tail part is separated from the connecting arm of a terminal carrier (not depicted). Furthermore, the lower surface 62b of the tail part 62 is adjacent to the end surface 62a and connected to the conductive trace of the first board and is a connecting surface that is connected, by soldering or the like, to a connection pad formed on a surface of the first board. Note that the conductive trace is typically a signal line but also may be a power line.

Each first terminal 61 is a member formed by bending a thin metal strip extending in the width direction (Y-axis direction) of the first connector 1 in the vertical direction (Z-axis direction), and each first terminal is preferably formed so that the dimension thereof in the width direction (X-axis direction) is approximately constant (for example, approximately 0.12 mm).

Note that in the case of a first terminal 61 in which the tail part 62 extends inward in the width direction (Y-axis direction) of the first connector 1, in other words, in which the tail part 62 extends into the recessed groove part 13, the length of the tail part 62 is preferably formed to be shorter than that of a first terminal 61 in which the tail part 62 extends outward in the width direction (Y-axis direction) of the first connector 1. As a result, as depicted in FIG. 5B, the length of the tail part 62 protruding from the inner surface 12c side of the bottom plate part 17 where the flange 17a is not formed is approximately equal to the length of the tail part 62 protruding from the flange 17a on the outer surface 12b side of the bottom plate part 17, so the tail part 62 can easily be connected to a connection pad formed on the surface of the first board by soldering, and the like. Furthermore, the possibility of contact between the tail part 62 extending from the left half body part 10A into the recessed groove part 13 and the tail part 62 extending from the right half body part 10B into the recessed groove part 13 is eliminated; facilitating connection work such as soldering the tail part 62 to a large number of connection pads formed on the surface of a narrow area of the first board corresponding to the narrow space of the recessed groove part 13.

As described above, in each of the terminal rows 60, the first terminals 61A and first terminals 61B are alternately arranged, or a first terminal row 60 and an adjacent terminal row 60 are arranged so the first terminals 61A are mutually aligned and the first terminals 61B are mutually aligned, with regards to the width direction (Y-axis direction) of the first connector 1. Therefore, in the example depicted in FIG. 5B, the first terminal 61 positioned at the front end (end in the X-axis positive direction) of the terminal row 60 positioned on the upper side is the first terminal 61B, and the orientation is such that the tail part 62 protrudes toward the inside in the width direction of the first connector 1, whereas the first terminal 61 positioned second from the front end is first terminal 61A, and the orientation is such that the tail part 62 protrudes toward the outside in the width direction of the first connector 1. In this manner, the first terminals 61 are mounted on the first protrusion 12 arranged in a line in mutually opposing directions, so the pitch of the tail parts 62 protruding from both sides of the first protrusion 12 is twice that of the pitch of the first terminal 61. In addition, the tail part 62 of the first terminal 61 supported by a first side wall part 18 that is the tail part 62 extending toward a second side wall part 18, and the tail part 62 of the first terminal 61 supported by the second side wall part 18 that is the tail part 62 extending toward the first side wall part 18 are arranged so as to be mutually shifted by half a pitch in a staggered pattern. That is, the plurality of tail parts 62 in the first connector 1 are arranged in four rows overall, in a staggered pattern. This configuration facilitates the operation of connecting the first terminal to the connection pad of the first board by soldering or the like.

Furthermore, with the first terminals 61 in a state of being integrated with the first housing 11, the upper surface of the connecting part 64 is positioned roughly the same as the mating surface 12a that is the upper surface of the first protrusion 12. In other words, the upper surface of the connecting part 64 of each of the first terminals 61 is substantially flush with the mating surface 12a of the first protrusion 12.

Furthermore, the second contact surface 63a of the outer column part 63 of the first terminal 61 and the first contact surface 65a of the inner column part 65 are approximately flush with the outer surface 12b and inner surface 12c of the first protrusion 12 of the side wall part 18, and the first contact surface 65a is approximately flush with the second contact surface 63a. That is, on both sides of the first protrusion 12, in the width direction (Y-axis direction) of the first connector 1, the first contact surface 65a and the second contact surface 63a of each first terminal 61 are positioned corresponding to the outer surface 12b and the inner surface 12c, and the first contact surface 65a and the second contact surface 63a are positioned at positions corresponding to each other. In other words, the contact surfaces of the first terminals 61 in each terminal row 60 can be said to be in-line on both sides of the first protrusion 12, or the plurality of first terminals 61 in each terminal row 60 can be said to be in-line.

On the other hand, between the contact surfaces of adjacent first terminals 61 in the terminal row 60, i.e., between adjacent first contact surface 65a and second contact surface 63a, the recessed part 12d is formed that is indented toward the center of the first protrusion 12 in the thickness direction (Y-axis direction). However, the widthwise dimension (X-axis direction) of the recessed part 12d is formed to be narrower than the width of the contact surface of the first terminal 61, preferably narrower than the width dimension of the second terminal 161, more preferably narrower than the width dimension of the contact part 167 of the second terminal 161 described later, and even more preferably narrower than the proximal contact protrusion 166a and distal contact protrusion 165a of the contact part 167 described later (for example, approximately 0.065 mm). As a result, when the first connector 1 and the second connector 101 are in a mated state, even if the relative positions of the first connector 1 or the second connector 101 in the longitudinal direction (X-axis direction) are offset, the contact part 167 of the second terminal 161 will not become stuck in the recessed part 12d.

Note that for each of the terminal rows 60, there are inter-terminal walls 12e between adjacent outer column parts 63, inner column parts 65, and connecting parts 64 of adjacent first terminals 61, and these inter-terminal walls 12e are integrated with the outer column parts 63, inner column parts 65, and connecting parts 64. As a result, insulation is reliably maintained between adjacent first terminals 61 while the first terminals 61 are firmly retained in the first protrusions 12 of the side wall part 18.

In addition, the lower surface 62b of the tail part 62 of each first terminal 61 is positioned at approximately the same position as the lower surface 17c of the bottom plate part 17, that is, is approximately flush with the lower surface 17c of the bottom plate part 17. Furthermore, the lower surface 62b of the tail part 62 is exposed from the lower surface 17c of the bottom plate part 17. On the other hand, the bottom plate part 17 covers at least a part of the upper surface of the tail part 62 of the first terminal 61. Furthermore, at least a part of the upper surface of the tail part 62 that protrudes toward the outer surface 12b of the first protrusion 12 is also covered by the flange 17a. At least the midpoint of the range from the location adjacent to the outer column part 63 to the end surface 62a of the tail part 62 in the width direction (Y-axis direction) of the first protrusion 12 is desirably covered by the bottom plate part 17 and the flange 17a. In addition, the anchor part 65b positioned on the opposite side of the tail part 62 in the width direction of the first protrusion 12 is embedded in the bottom plate part 17. Thereby, the first terminal 61 including the tail part 62 and the anchor part 65b are more firmly held by the first protrusion 12 of the side wall part 18.

Note that in addition, slit-shaped grooves 17b extending in the width direction of the first protrusion 12 may be formed in the bottom plate part 17 and the flange 17a at locations corresponding to each tail part 62.

On the other hand, the end surface of the free end of the inner column part 65, in other words, the lower surface of the anchor part 65b, is positioned at a higher position (Z-axis positive direction) than lower surface 17c of the bottom plate part 17, but at least a part thereof is exposed when viewed from the mounting surface (lower surface 17c) side.

It should be noted that, a connecting agent such as solder or the like is applied to a portion that protrudes outward from the bottom plate part 17 on the lower surface 62b of the tail part 62. However, the distance from that portion to the second contact surface 63a exposed on both the left and right side surfaces of the first protrusion 12 is long in the width direction (Y-axis direction) and up-down direction (Z-axis direction) of the first protrusion 12, so the connecting agent such as solder or the like does not adhere to the second contact surface 63a due to the so-called solder rise. In addition, the distance from the aforementioned portion to the first contact surface 65a adjacent to the second contact surface 63a is long in the width direction, longitudinal direction (X-axis direction), and up-down direction of the first protrusion 12, and since insulating material constituting the first housing 11 is present, the connecting agent such as solder or the like does not adhere to the first contact surface 65a due to solder wicking.

In the present embodiment, the first terminals 61 are assumed to have a highly conductive metal such as gold, nickel, palladium, or the like that is typically used for connectors plated on the surface thereof to reduce electrical resistance. However, the end surface 62a of the tail part 62 of the first terminal 61, which is the cut surface generated by being cut off from the connecting arm of the terminal carrier (not depicted), is not plated.

With the first connector 1 and second connector 101 in a mated state, the first protruding end part 16 is a portion that functions as an insert protrusion inserted in a mating recessed part 122 of the second protruding end part 121, described later, provided on the second connector 101 and the first reinforcement fitting 51 is integrally mounted thereto.

An extended end part 14 extending in the longitudinal direction is integrally connected to both longitudinal ends of the first protrusion 12 of the side wall part 18 in each half body part 10, and an embedded part 15 extending further in the longitudinal direction of the first protrusion 12 is integrally connected to each extended end part 14. Note that the extended end parts 14 extend obliquely inward, while the embedded parts 15 extend in the longitudinal direction from an inwardly-eccentric position at the tip end of the extended end parts 14 and are positioned inward from the outer surface 12b of the first protrusion 12. In other words, the extended end part 14 of the left half body part 10A extends obliquely in the right direction (Y-axis negative direction), while the embedded part 15 extends longitudinally from a position eccentric in the right direction at the tip end of the extended end part 14. In addition, the extended end part 14 of the right half body part 10B extends obliquely in the left direction (Y-axis positive direction), while the embedded part 15 extends longitudinally from a position eccentric in the left direction at the tip end of the extended end part 14.

Furthermore, at least part of the extended end part 14 of the left and right half body parts 10 and the entire embedded part 15 are covered by a first protruding end part 16 formed from an insulating material such as a synthetic resin or the like. That is, at least a part of the extended end part 14 and the entire embedded part 15 are embedded within the first protruding end part 16.

Specifically, the first protruding end part 16 is formed by performing insert molding with the embedded parts 15 of the left and right half body parts 10 arranged in proximity to one another and covered by the first reinforcement fitting 51. Thereby, a first protruding end part 16 integrating the extended end part 14, the embedded part 15, and the first reinforcement fitting 51 of the left and right half body parts 10 is formed, and the side wall parts 18 of the left and right half body parts 10 are joined together. The first protruding end part 16 does not necessarily cover the entire embedded part 15, but may cover the embedded part 15 to a degree sufficient to join the right and left half body parts 10. However, the entire embedded part 15 is preferably covered to increase the binding strength to the highest degree. It should be noted that the first protruding end part 16 is a member formed so as to be integrated with other members by insert molding and is not an independent member separate from other members. It should, however, be noted that, for convenience of description, the first protruding end part 16 in FIG. 3 is depicted as being an independent member.

In this manner, as the extended end part 14 extends inwardly at an oblique incline and the embedded part 15 is positioned inwardly from the outer surface 12b of the first protrusion 12, the width (dimension in the Y-axis direction) of the first protruding end part 16 may be made smaller than the width (distance between the outer surface 12b of the left and right first protrusion 12) of the first connector 1. Note that in the event the width of the first protruding end part 16 does not need to be smaller than the width of the first connector 1, the extended end part 14 does not necessarily have to be inclined obliquely inward, but rather may extended directly. Furthermore, the extended end part 14 may be omitted by extending the embedded part 15 directly from both ends in the longitudinal direction of the first protrusion 12. In this case, the longitudinal dimension of the first connector 1 may be shortened. Furthermore, when three or more half body parts 10 are arranged in parallel, the extended end part 14 may be extended so as to have a Y-shape from both ends in the longitudinal direction of the first protrusion 12.

The first reinforcement fitting 51 is a member integrally formed by subjecting a metal plate to processing such as punching and bending, and includes a top plate 54 that extends in the width direction of the first housing 11, and a substantially rectangular leg part 55 connected to both the left and right edges of the top plate 54 and that extends downwardly, is connected to both the front and rear edges of the top plate 54, and includes the end wall outer surface cover part 52 and end wall inner surface cover part 53 that extend downwardly. Note that a tail part 52a is connected to the lower end of the end wall outer surface cover part 52 as a board connection part. The width of the end wall outer surface cover part 52 is larger than the width of the end wall inner surface cover part 53.

As described above, the first reinforcement fitting 51 is integrated with the first protruding end part 16. Furthermore, the top plate 54 is embedded in the upper surface of the first protruding end part 16. In this state, the upper surface of the top plate 54 is flush with the upper surface of the first protruding end part 16 and constitutes over half the area of the upper surface of the first protruding end part 16. In addition, the right and left leg parts 55 are embedded in the right and left outer surfaces of the first protruding end part 16. The outer surface of the leg part 55 is flush with the outer surface of the first protruding end part 16 and constitutes over half the area of the outer surface of the first protruding end part 16. Furthermore, the end wall outer surface cover part 52 and the end wall inner surface cover part 53 are embedded in the end wall outer surface and the end wall inner surface of the first protruding end parts 16. The respective outer surfaces of the end wall outer surface cover part 52 and the end wall inner surface cover part 53 are flush with the end wall outer surface and the end wall inner surface of the first protruding end part 16 and constitute over half of the end wall outer surface and over half the area of the end wall inner surface of the first protruding end part 16.

Note that the tail part 52a is connected to the lower end of the end wall outer surface cover part 52 at an angle of approximately 90 degrees, extends outward in the longitudinal direction of the first housing 11 and is connected by soldering or the like to a connection pad connected to a conductive trace of the first board. Furthermore, the conductive trace is typically a power line but also may be a signal line. Note that if necessary, a lower end part 55a of the leg part 55 may be arranged to approach or abut against the surface of the first board. In this case, by connecting the lower end part 55a to the connection pad of the first board by soldering or the like as a board connection part, the connection strength of the first reinforcement fitting 51 to the first board is improved, and connection to a power line or a signal line, as with the tail part 52a, is also feasible.

Note that furthermore, whether the recessed groove part 13 is a single through hole or a bottomed hole with a bottom plate, the pair of half body parts 10 as the first housing 11 and the pair of first protruding end parts 16 as a pair of end walls may be integrally molded with the first terminal 61 and the first reinforcement fitting 51 by a single insert molding. Furthermore, the first reinforcement fitting 51 may not be integrally molded, but may be press-fitted into the first housing 11 or the first protruding end part 16 to be retained therein.

Next, the configuration of the second connector 101 that constitutes a connector assembly together with the first connector 1 will be described.

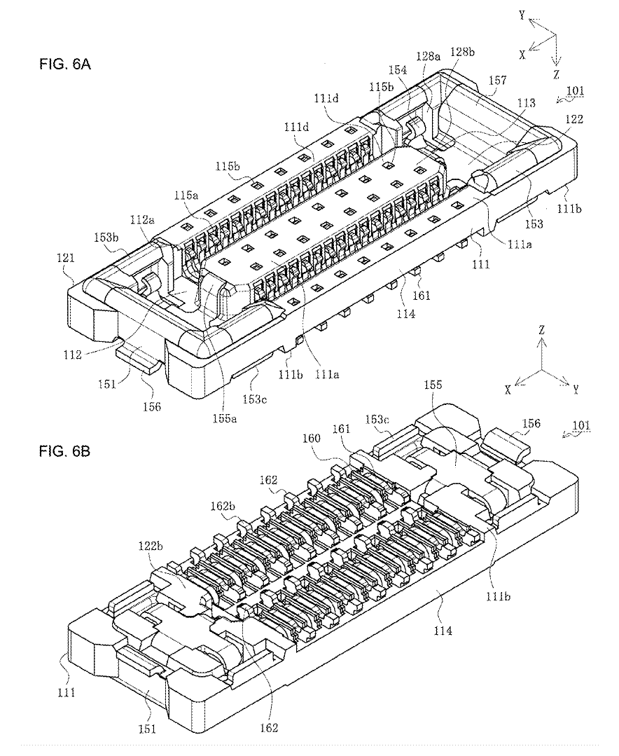

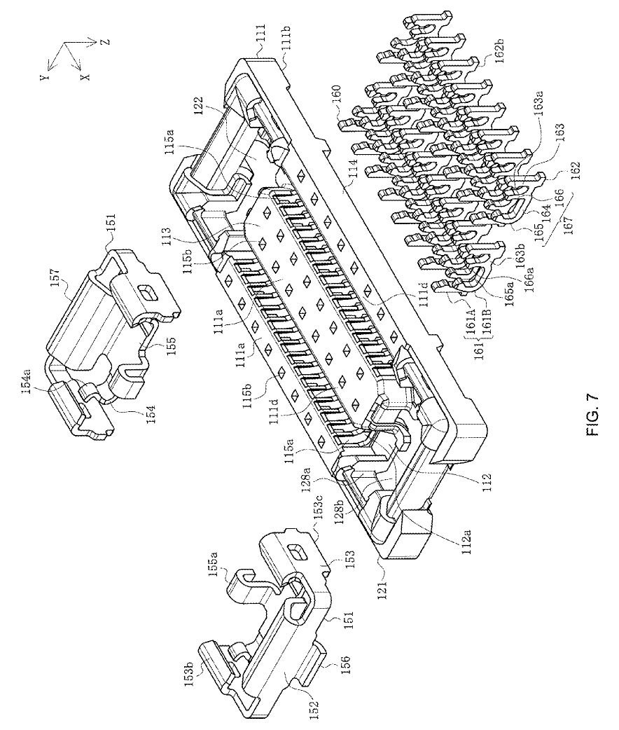

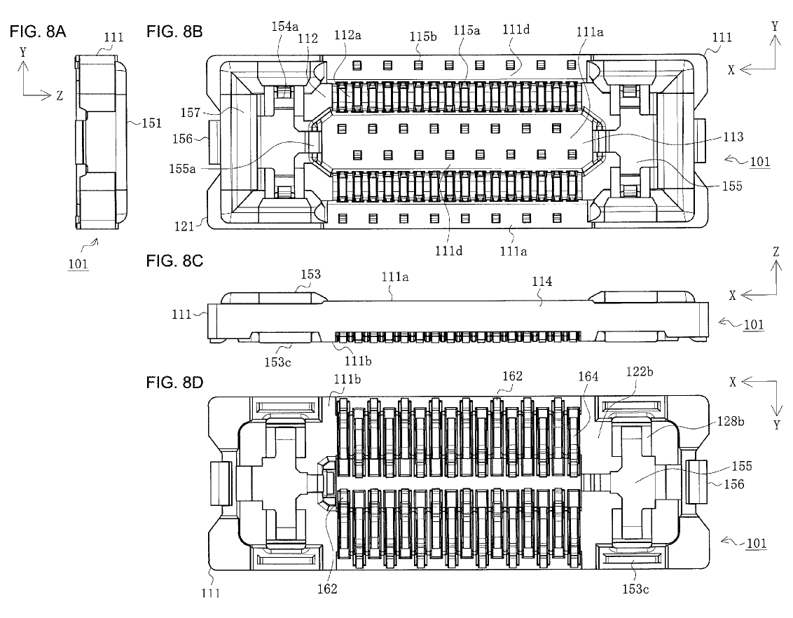

FIGS. 6A and 6B are perspective views of the second connector according to Embodiment 1. FIG. 7 is an exploded perspective view of the second connector according to Embodiment 1. FIGS. 8A,8B, 8C and 8D are a four-plane diagram of the second connector according to Embodiment 1. Note that FIG. 6A is a view from the mating surface side, and FIG. 6B is a view from the mounting surface side, and FIG. 8A is a front view, FIG. 8B is a top view, FIG. 8C is a side view, and FIG. 8D is a bottom view.

The second connector 101 as a counterpart connector, which is a receptacle connector in the present embodiment, has a second housing 111 as a counterpart housing, which is a receptacle housing integrally formed from an insulating material such as synthetic resin. An upper wall surface 111a, which is the upper surface of the wall part of the second housing 111, is the surface of the second housing 111 on which the first connector 1 is mated, that is, the mating surface. As depicted in the figure, the second housing 111 has a substantially thick rectangular plate-like shape that is a substantially rectangular parallelepiped. A generally rectangular recessed part 112 that is surrounded by a periphery and fits into the first housing 11 is formed on the upper wall surface 111a side (Z-axis negative direction side). Furthermore, the second protrusion 113 is integrally formed with the second housing 111 as an insular part to be mated with the recessed groove part 13 in the recessed part 112. Moreover, the side wall parts 114 extending parallel with the second protrusion 113 on both sides of the second protrusion 113 are integrally formed with the second housing 111. Here, the upper surface of the second protrusion 113 is also in the same plane as the upper wall surface 111a, and therefore will be referred to as the upper wall surface 111a.

The second protrusion 113 and the side wall parts 114 protrude upwardly (Z-axis negative direction) from the bottom surface of the recessed part 112 and extend in the longitudinal direction of the second connector 101. Consequently, a recessed groove part 112a that is an elongated recessed part extending in the longitudinal direction (X-axis direction) of the second connector 101 is formed as a portion of the recessed part 112 on both the sides of the second protrusion 113.

A second terminal stowing groove cavity 115a in the shape of a recessed groove is formed on the side surfaces of both sides of the second protrusion 113 and the side surfaces of the inside of the side wall parts 114. In addition, a second terminal stowing hole cavity 115b in the shape of a hole is formed on the second protrusion 113 and the side wall parts 114. Furthermore, the second terminal stowing groove cavity 115a and the second terminal stowing hole cavity 115b are connected and integrated with each other on the bottom surface of the recessed groove part 112a. The second terminal stowing groove cavity 115a and the second terminal stowing hole cavity 115b are therefore described as a second terminal stowing cavity 115 when collectively described. The second terminal stowing cavities 115 are provided at a pitch corresponding to the first terminals 61 and at the corresponding appropriate number. Furthermore, each second terminal stowing cavity 115 stows the second terminals 161 as counterpart terminals; thereby, the plurality of second terminals 161 are aligned in each recessed groove part 112a at a pitch and quantity corresponding to the first terminals 61 (16 pieces in the example depicted in the figures).

The second terminal 161 is a member integrally formed by subjecting a conductive metal plate to processing such as punching, and includes a main body part 163 extending in the vertical direction (Z-axis direction), a tail part 162 as a board connection part formed and connected to the lower end (Z-axis positive direction end) of the main body part 163, a proximal connection part 163b as a second connecting part extending from near the lower end of the main body part 163 in the width direction (Y-axis direction) of the second connector 101, a proximal contact part 166 as a second arm part extending in the vertical direction and connected near the lower end thereof to the tip end of the proximal connection part 163b, a distal connection part 164 extending in the width direction of the second connector 101 from the lower end of the proximal contact part 166, and a distal contact part 165 as a first arm part extending upward (Z-axis negative direction) from the tip end of the distal connection part 164.

When describing the proximal contact part 166 as the second arm part, the distal contact part 165 as the first arm part, and the distal connection part 164 as the connecting part connecting them together, they will be described as contact part 167. The contact part 167 is an elastically deformable portion that comes into contact with the first terminal 61 and has a generally U-shape as a whole.

Note that a proximal contact protrusion 166a and a distal contact protrusion 165a are preferably formed facing each other near the tip ends of the proximal contacting part 166 and the distal contacting part 165. Furthermore, the main body part 163 is a portion that functions as a press-fit part that is pressed into and retained in the second terminal stowing hole cavity 115b, and an engaging protrusion 163a that bites into the side surface of the second terminal stowing hole cavity 115b is preferably formed near the tip end thereof.

In addition, the tail part 162 is bent and connected to the lower end of the main body part 163, extends in the width direction of the second housing 111, and a lower surface 162b thereof is connected to the connection pad coupled with the conductive trace of the second board by soldering or the like. Note that the conductive trace is typically a signal line but also may be a power line. Furthermore, the proximal contacting part 166 and the distal contacting part 165 are portions that contact the first terminals 61 provided in the first connector 1 when the first connector 1 and the second connector 101 are mated. The proximal contact protrusion 166a and the distal contact protrusion 165a contact the first contact surface 65a and the second contact surface 63a that are the contact surfaces of the first terminal 61, and preferably engage with the upper end protrusion 64a.

The second terminal 161 is inserted into the second terminal stowing cavity 115 from the lower part of the second housing 111 and mounted in the second housing 111. Therefore, the main body part 163 is press fit and retained in the second terminal stowing hole cavity 115b, the proximal contacting part 166 and distal contacting part 165 are exposed in the recessed groove part 112a, and the lower surface 162b of the tail part 162 of the second terminal 161 is exposed to a mounting surface 111b as the lower surface of the second housing 111. Note that the side edge of the upper wall surface 111a on the side of the recessed groove part 112a forms an overhang part 111d that projects toward the center of the width of the recessed groove part 112a so as to cover at least a part above the second terminal stowing groove cavity 115a. The overhang part 111d is configured to cover at least a part of the upper surfaces of the proximal contact part 166 and the distal contact part 165 of the second terminal 161 stowed in the second terminal stowing groove cavity 115a.

In addition, the second terminals 161 attached to each recessed groove part 112a form a plurality of terminal rows 160 (two in the example depicted in the figure), which are rows extending in the longitudinal direction of the second connector 101 along each recessed groove part 112a. In addition, the second terminals 161 include a first type of terminals that are second terminals 161A and a second type of terminals that are second terminals 161B. Furthermore, in each terminal row 160, the second terminals 161A and the second terminals 161B are arranged alternately. In addition, a first terminal row 160 and an adjacent second terminal row 160 are arranged so that the second terminals 161A and the second terminals 161B are lined up in the width direction (Y-axis direction) of the second connector 101.

In the example depicted in FIG. 7, of the second terminals 161 mounted in the recessed groove part 112a, the second terminals 161 positioned at the front end (X-axis positive direction end) are oriented such that the tail part 162 protrudes in the Y-axis negative direction, while the second terminals 161 positioned second from the front end are oriented such that the tail part 162 protrudes in the Y-axis positive direction. In this manner, as the second terminals 161 are mounted in the recessed groove part 112a arranged in a line in alternating directions, the pitch of the tail parts 162 exposed on the mounting surface 111b on both sides of the recessed groove part 112a is set to twice the pitch of the second terminals 161. Furthermore, the tail parts 162 of the second terminals 161 attached to the first of the recessed groove parts 112a and extending toward the second recessed groove part 112a, and the tail parts 162 of the second terminals 161 attached to the second recessed groove part 112a and extending toward the first recessed groove part 112a, are arranged so as to be offset from each other by half a pitch and form a staggered pattern. That is, the plurality of tail parts 162 of the second connector 101 are arranged in four rows overall, in a staggered pattern. This configuration facilitates the operation of connecting the second terminal to the connection pad of the second board by soldering or the like. In addition, the pitch of the proximal contacting part 166 and the distal contacting part 165 exposed to the recessed groove part 112a is two times the pitch of the second terminals 161.

Each second terminal 161 is preferably formed with at least the dimension of the contact part 167 in the width direction (X-axis direction) being substantially constant, and larger than the dimension in the width direction (X-axis direction) between adjacent first terminals 61 in the terminal row 60, in other words, the width-direction dimension of the inter-terminal wall 12e and at least with a dimension greater than the dimension of the recessed part 12d in the width direction formed in the inter-terminal wall 12e (for example, about 0.08 mm). More preferably, at least the widthwise dimension of the proximal contact protrusion 166a of the proximal contact part 166 and the distal contact protrusion 165a of the distal contact part 165 in the contact part 167 are formed to be larger than the widthwise dimension of the recessed part 12d. As a result, when the first connector 1 and the second connector 101 are in a mated state, even if the relative positions of the first connector 1 or the second connector 101 in the longitudinal direction (X-axis direction) are offset, the contact part 167 of the second terminal 161 will not become stuck in the recessed part 12d.

Note that in addition, in the second terminal 161 in which the tail part 162 extends inward in the width direction (Y-axis direction) of the second connector 101, the protruding length of the tail part 162 from the lower end of the main body part 163 is preferably shorter than in the second terminal 161 in which the tail part 162 extends outward in the width direction (Y-axis direction) of the second connector 101, and the lower surface 162b of the tail part 162 is preferably formed to be closer to the proximal contact part 166. As a result, the lower surface 162b of the tail part 162 positioned below the second protrusion 113 is spaced away from the widthwise center of the second connector 101, eliminating the possibility of the tail parts 162 extending from the terminal rows 160 on both the left and right sides toward the inside of the second connector 101 in the width direction and coming into contact with each other, and facilitating the operation of connecting such as soldering the lower surface 162b of the tail part 162 to connection pads formed in large numbers on the surface of a narrow area of the second board corresponding to the area below the second protrusion 113.

The second protruding end parts 121 are disposed as mating guide parts on both ends in the longitudinal direction of the second housing 111. The mating recessed parts 122 are formed as part of the recessed part 112 in each second protruding end part 121. The mating recessed part 122 is a recessed part having a substantially rectangular planar shape, and is connected to both longitudinal ends of each recessed groove part 112a. Furthermore, the first protruding end part 16 provided on the first connector 1 is inserted in a state in which the first connector 1 and the second connector 101 are mated inside the mating recessed part 122.

Furthermore, a second reinforcement fitting 151 as a counterpart reinforcement fitting is attached to the second protruding end part 121. Note that the second reinforcement fitting 151 is a member that is integrated with the second housing 111 by insert molding, and therefore does not exist independently and separated from the second housing 111. However, the second reinforcement fitting is depicted in FIG. 7 as being present independently for convenience of explanation. Furthermore, the location on the second housing 111 where the second reinforcement fitting 151 is attached does not exist separately from the second reinforcement fitting 151.

The second reinforcement fitting 151 is a member integrally formed by subjecting a metal plate to processing such as punching and bending, and includes a second main body part 152 extending in the width direction of the second housing 111, side cover parts 153 connected to both left and right ends of the second main body part 152, a tail part 156 connected to the lower end of the second main body part 152, an end wall cover part 157 connected to the upper end of the second main body part 152, a recess cover part 155 connected to the end wall cover part 157, and contact arm parts 154 as a pair of left and right elastic members connected to both left and right side edges of the recess cover part 155. The tail part 156 extends facing outwards in the longitudinal direction of the second connector 101 and is connected to a connection pad (not depicted) by soldering or the like connected to a conductive trace on the second board. Note that the conductive trace is typically a power line but also may be a signal line. In addition, a lower end 153c of the side cover parts 153 may get close to or come into contact with the surface of the second board, as necessary. In this case, the lower ends 153c of the side cover parts 153 are connected to connection pads on the second board by soldering or the like as board connection parts, thereby improving the connection strength of the second reinforcement fitting 151 to the second board.

Upper ends of each of the side cover parts 153 are connected by a side wall upper cover part 153b. This side wall upper cover part 153b is bent more than 90 degrees and the tip end thereof extends obliquely downward facing the inside of the mating recessed part 122. In addition, a contact protrusion 154a is formed near an upper end, in other words, a tip end of the contact arm part 154 as a contact part is formed in a shape so as to swell towards the center in the width direction of the second housing 111. Furthermore, an island end cover part 155a is connected to the tip end of the recess cover part 155, centered in the width direction of the second connector 101.

Furthermore, the recess cover part 155 is stored in a bottom plate opening 128b formed penetrating a bottom plate 122b of the mating recessed part 122 in the plate thickness direction (Z-axis direction). In addition, the contact arm part 154 is stored in the bottom plate opening 128b and a side wall recessed part 128a formed on the inner surface of the mating recessed part 122 continuous with the bottom plate opening 128b. Note that the contact arm part 154 is not integrated with the second housing 111 and is stored in an elastically deformable state in the bottom plate opening 128b and the side wall recessed part 128a. Therefore, the contact arm part 154 that functions as an elastic member has a long spring length and may exhibit a spring force, thus applying contact pressure on the contact protrusion 154a for securely retaining the contact protrusion 154a on the first reinforcement fitting 51.

In addition, the island end cover part 155a covers both ends of the second protrusion 113, or in other words, the island ends, with at least the tip end part embedded. Therefore, both ends in the longitudinal direction of the second protrusion 113 will not break when the first connector 1 and the second connector 101 are mated even if a portion comes into contact with the first connector 1.

Subsequently, the operation of mating together the first connector 1 and the second connector 101 with the above configuration will be described.

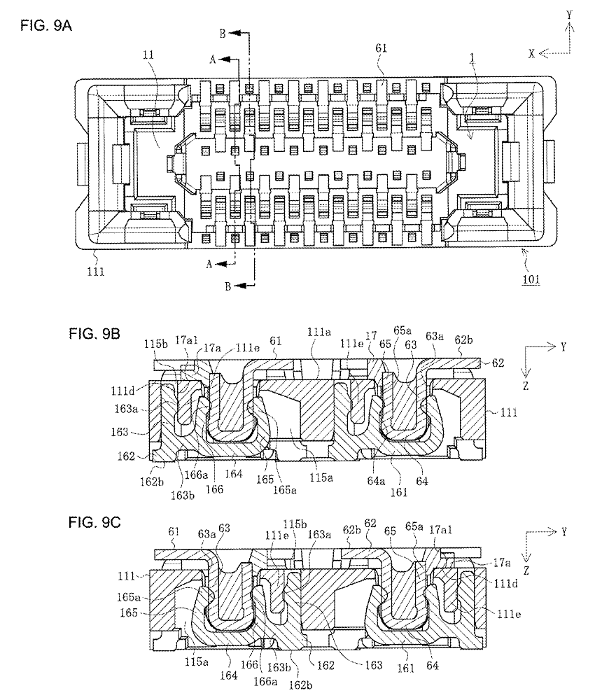

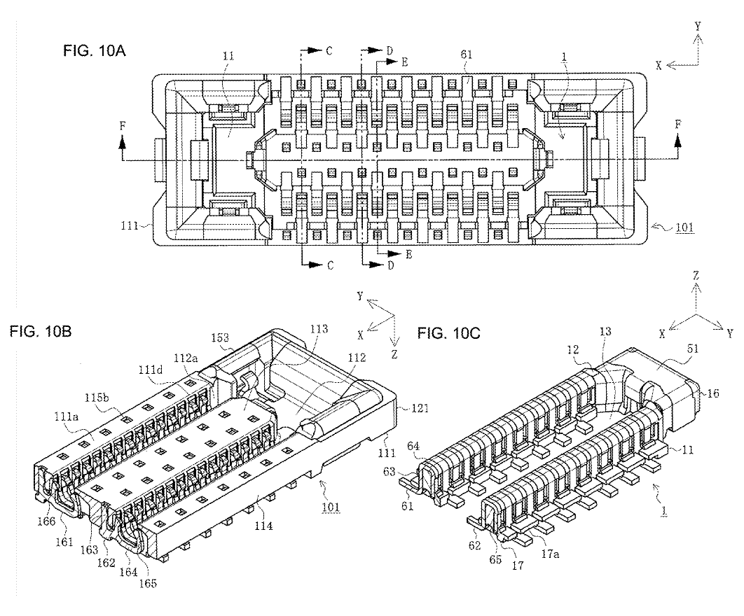

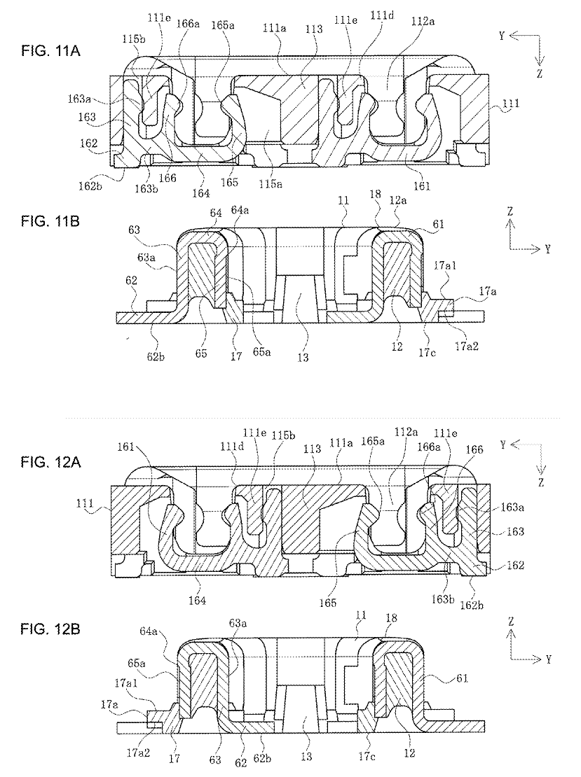

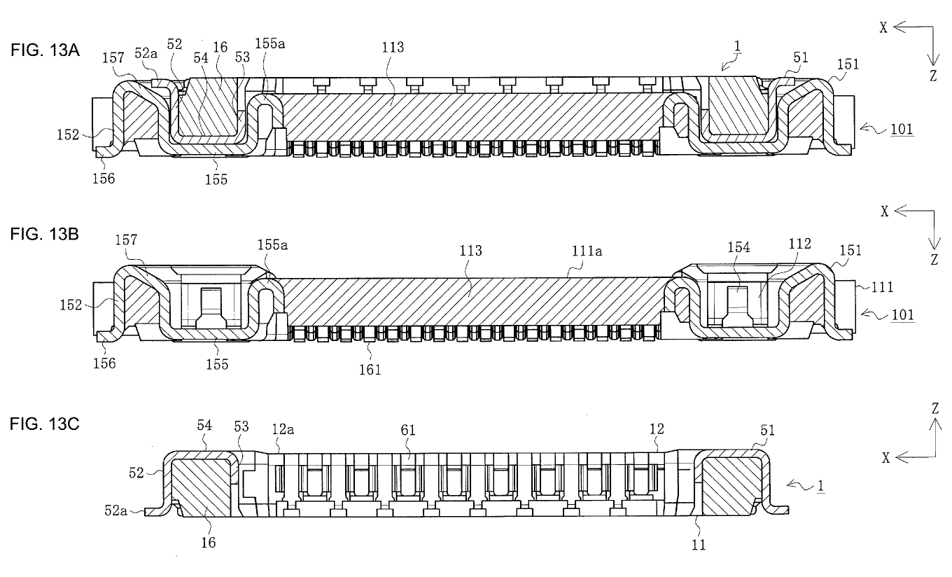

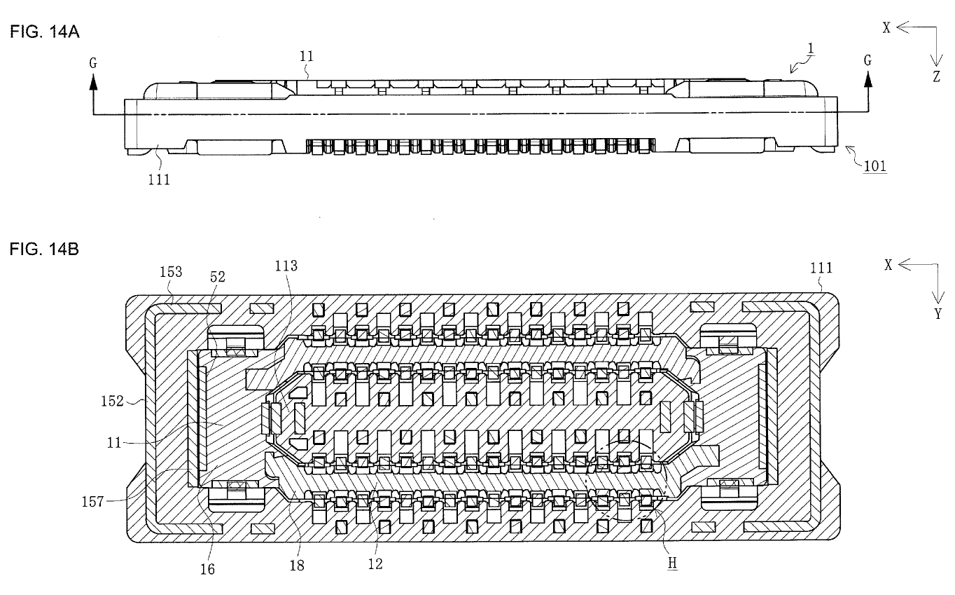

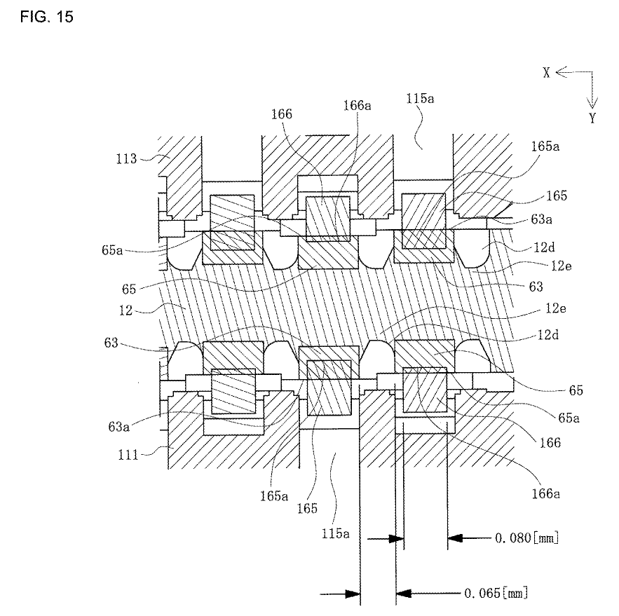

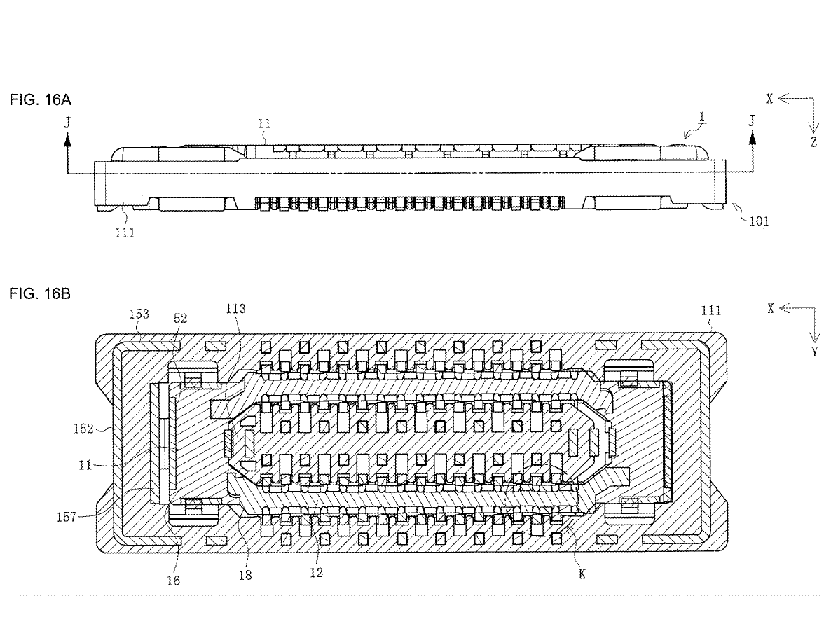

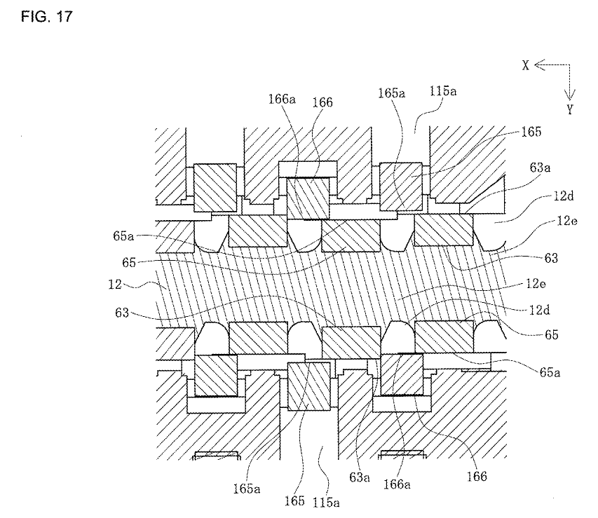

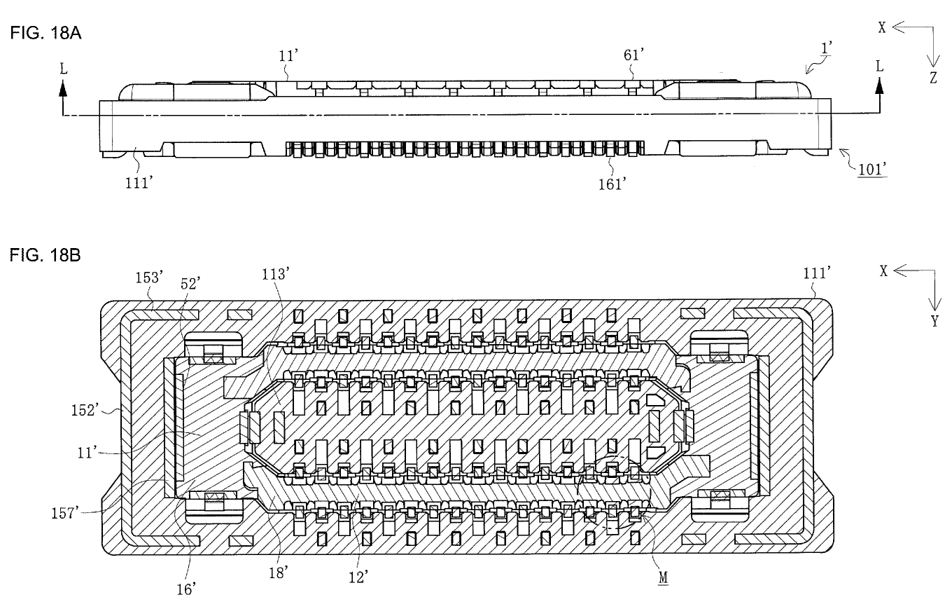

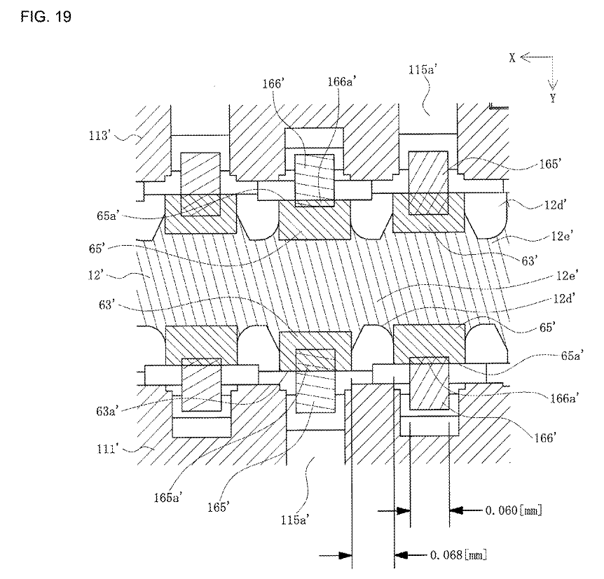

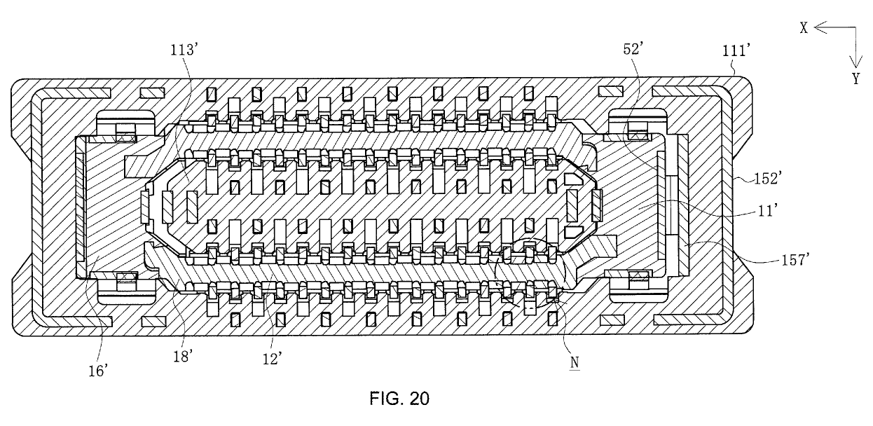

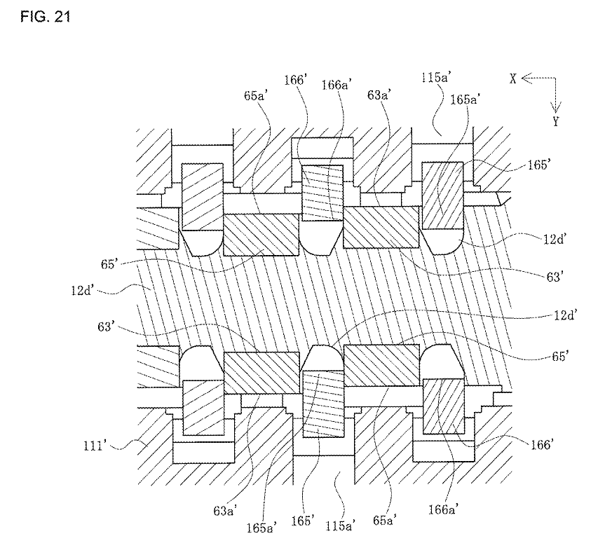

FIG. 9 is a first three-plane diagram depicting the first connector and second connector according to Embodiment 1 in a mated state. FIG. 10 is a second three-plane diagram depicting the first connector and the second connector according to Embodiment 1 in a mated state. FIG. 11 is a first transverse cross-sectional view of the first connector and the second connector according to Embodiment 1 in a mated state. FIG. 12 is a second transverse cross-sectional view of the first connector and the second connector according to Embodiment 1 in a mated state. FIG. 13 is a longitudinal cross-sectional view of the first connector and the second connector according to Embodiment 1 in a mated state. FIG. 14 is a two-plane diagram depicting the first connector and the second connector according to Embodiment 1 in a mated state. FIG. 15 is an enlarged cross-sectional view of the first connector and the second connector according to Embodiment 1 in a mated state, and is an enlarged view of part H in FIG. 14B. FIG. 16 is a two-plane diagram depicting a case where the relative positions of the first connector and the second connector in a mated state according to Embodiment 1 are offset. FIG. 17 is an enlarged cross-sectional view of a case where the relative positions of the first connector and the second connector in the mated state according to Embodiment 1 are offset, and is an enlarged view of part K in FIG. 16B. FIG. 18 is a two-plane diagram depicting the first connector and the second connector according to a reference example in a mated state. FIG. 19 is an enlarged cross-sectional view of the first connector and the second connector in the reference example in a mated state, and is an enlarged view of part M in FIG. 18B. FIG. 20 is a cross-sectional view depicting a case where the relative positions of the first connector and the second connector in a mated state according to the reference example are offset, and is a cross-sectional view corresponding to the cross section along line L-L in FIG. 18A. FIG. 21 is an enlarged cross-sectional view in which the relative positions of the first connector and the second connector in a mated state according to the reference example are offset, and is an enlarged view of part N in FIG. 20. Note that furthermore, FIG. 9A is a plan view of the first connector seen from the side, FIG. 9B is a cross-sectional view along line A-A in FIG. 9A, and FIG. 9 is a cross-sectional view along line B-B in FIG. 9A. FIG. 10A is a plan view as viewed from the first connector side, FIG. 10B is a perspective view of the second connector along line C-C in FIG. 10A, and FIG. 10C is a perspective view of the first connector including a cross section along line C-C in FIG. 10A. FIG. 11A is a cross-sectional view of the second connector along line D-D in FIG. 10A, and FIG. 11B is a cross-sectional view of the first connector along line D-D in FIG. 10A. FIG. 12A is a cross-sectional view of the second connector along line E-E in FIG. 10A, and FIG. 12B is a cross-sectional view of the first connector along line E-E in FIG. 10A. FIG. 13A is a cross-sectional view along line F-F in FIG. 10A, FIG. 13B is a cross-sectional view of the second connector along line F-F in FIG. 10A, and FIG. 13C is a cross-sectional view of the first connector along line F-F in FIG. 10A. FIG. 14A is a side view and FIG. 14B is a cross-sectional view along line G-G in FIG. 14A. FIG. 16A is a side view and FIG. 16B is a cross-sectional view along line J-J in FIG. 16A. FIG. 18A is a side view and FIG. 18B is a cross-sectional view along line L-L in FIG. 18A.

Here, for the sake of convenience, an example will be described in which the first connector 1 is surface mounted on the first board by connecting the tail part 62 of the first terminal 61 by soldering or the like to a connection pad connected to a conductive trace on the first board (not depicted), and by connecting the tail part 52a at the lower end of the end wall outer surface cover part 52 of the first reinforcement fitting 51 and the lower end part 55a of the leg part 55 by soldering or the like to a connection pad connected to a conductive trace on the first board. Note that the conductive trace connected to the connection pad to which the tail part 62 of the first terminal 61 is connected is described as a signal line, and the conductive trace connected to the connection pad to which the tail part 52a and lower end part 55a of the first reinforcement fitting 51 are connected is described as a power line.

Similarly, an example will be described in which the second connector 101 is surface mounted on the second board by connecting the tail part 162 of the second terminal 161 by soldering or the like to a connection pad connected to a conductive trace on the second board (not depicted), and by connecting the tail part 156 of the second reinforcement fitting 151 and the lower end 153c of the side cover part 153 by soldering or the like to a connection pad connected to a conductive trace on the second board. Note that in addition, the conductive trace connected to the connection pad to which the tail part 162 of the second terminal 161 is connected is described as a signal line, and the conductive trace connected to the connection pad to which the tail part 156 and lower end 153c of the second reinforcement fitting 151 are connected is described as a power line.

First, an operator opposes the mating surface 12a of the first protrusion 12 as the mating surface of the first housing 11 of the first connector 1 and the upper wall surface 111a as a mating surface of the second housing 111 of the second connector 101, such that when the position of the first protrusion 12 of the first connector 1 is aligned with the position of the corresponding recessed groove part 112a of the second connector 101 and when the position of the first protruding end part 16 of the first connector 1 aligns with the position of the corresponding mating recessed part 122 of the second connector 101, position alignment of the first connector 1 and the second connector 101 is complete.

In this state, when the first connector 1 and/or the second connector 101 are moved in a direction approaching the other side, in other words, in a mating direction, the first protrusion 12 and the first protruding end part 16 of the first connector 1 are inserted into the recessed groove part 112a and the mating recessed part 122 of the second connector 101. Therefore, as depicted in FIGS. 1, 9, and the like, mating of the first connector 1 and the second connector 101 is complete.

Furthermore, the first terminals 61 and the second terminals 161 are placed in a conductive state. Specifically, as depicted in FIG. 9A and FIG. 9B, the outer column part 63, connecting part 64 and inner column part 65 of the corresponding first terminal 61 enter between the proximal contact part 166 and the distal contact part 165 of each second terminal 161. Furthermore, the proximal contact protrusion 166a of the proximal contacting part 166 and the distal contact protrusion 165a of the distal contacting part 165 come into contact with the second contact surface 63a of the outer column part 63 and first contact surface 65a of the inner column part 65 that are contact surfaces.

Here, the distance from the second contact surface 63a to the first contact surface 65a for each first terminal 61 is larger than the distance from the proximal contact protrusion 166a to the distal contact protrusion 165a for the second terminal 161 so that when the outer column part 63, connecting part 64, and inner column part 65 of the first terminal 61 enter in between the corresponding proximal contact part 166 and distal contacting part 165 of each second terminal 161, the second terminal 161 is elastically deformed, and the gap between the proximal contact protrusion 166a and the distal contact protrusion 165a increases. Therefore, because of the repulsive force of the second terminal 161, the proximal contact protrusion 166a and the distal contact protrusion 165a are in a state of being pressed against the second contact surface 63a and the first contact surface 65a, reliably maintaining the contact between the proximal contact protrusion 166a and distal contact protrusion 165a and second contact surface 63a and first contact surface 65a. Thus, the conducting state between the first terminal 61 and the second terminal 161 is reliably maintained.

Note that the second housing 111 of the second connector 101 in the present embodiment has a housing wall part 111e positioned between the main body part 163 as the press-fit part of the second terminal 161 and the contact part 167, as depicted in FIG. 9B and FIG. 9C, FIG. 11A, and FIG. 12A. The lower end of the housing wall part 111e faces the proximal connection part 163b of the second terminal 161 with a gap therebetween. When the first connector 1 and the second connector 101 are completely mated, as depicted in FIG. 9B and FIG. 9C, the upper surface 17a1 of the flange 17a formed on the bottom plate part 17 of the first housing 11 may abut against the upper wall surface 111a, which is the upper surface of the housing wall part 111e present on at least one side of the second housing 111 in the width direction (Y-axis direction). Preferably, more than half (50%) of the upper surface 17a1 of the flange 17a may come into contact with the upper wall surface 111a of at least one of the housing wall parts 111e. The upper wall surface 111a of the housing wall part 111e is formed up to an overhang part 111d that is a region that covers a part of the upper portion of the proximal contact part 166.

In the example depicted in FIG. 9B and FIG. 9C, the flange 17a is formed only on the outer edge of the bottom plate part 17 on the outer surface 12b side, but the flange 17a may also be formed on the outer edge of the bottom plate part 17 on the inner surface 12c side if necessary. In this case, the area in which the upper surface 17a1 of the flange 17a may abut the upper wall surfaces 111a of the housing wall parts 111e that are present on both sides of the second housing 111 in the width direction is wider.

In addition, the upper surface 17a1 of the flange 17a and/or the upper wall surface 111a of the housing wall part 111e functions as a reference surface for mating the first connector 1 and the second connector 101 together.

In this manner, the upper surface 17a1 of the flange 17a of the first housing 11 and the upper wall surface 111a of the housing wall part 111e of the second housing 111 may abut against each other. Therefore, even if, when the first connector 1 and the second connector 101 are in a mated state, an excessive load is applied to the first connector 1 and/or the second connector 101 in the mating direction for some reason (for example, the electronic device on which the connector assembly is mounted falls to the floor or another member collides with the electronic device, causing a large external force to be applied), the stability of the mated state between the first connector 1 and the second connector 101 is maintained, so that the first connector 1 and/or the second connector 101 will not be damaged and the first connector 1 and the second connector 101 will not be tilted relative to each other, and thereby enabling reliable maintaining of mating.

Furthermore, the upper surface 17a1 of the flange 17a of the first housing 11 may abut against the overhang part 111d on the upper wall surface 111a of the housing wall part 111e, which is a location close to the second terminal stowing hole cavity 115b into which the main body part 163 of the second terminal 161 in the second housing 111 is pressed and engaged. As a result, even if excessive load is applied in the mating direction, the load is received by the overhang part 111d, which is close to the second terminal stowing hole cavity 115b, which has a relatively high strength, and the stability of the mated state is more reliably maintained.

In addition, when the mating of the first connector 1 and the second connector 101 is completed and the first terminal 61 and the second terminal 161 are electrically connected, as depicted in detail in FIGS. 14B and 15, the proximal contact protrusion 166a of the proximal contact part 166 of each second terminal 161 and the distal contact protrusion 165a of the distal contact part 165 come into contact with the second contact surface 63a of the outer column part 63 and the first contact surface 65a of the inner column part 65, which are the contact surfaces of the corresponding first terminal 61. Note that the recessed part 12d is formed in the inter-terminal wall 12e between adjacent first terminals 61 in the longitudinal direction (X-axis direction) of the first connector 1, and is indented toward the center of the first protrusion 12 in the thickness direction (Y-axis direction).

In the example depicted in the figure, the recessed part 12d is a groove-shaped recessed indent part having an approximately U-shaped cross-section in cross section (X-axis-Y-axis cross section), with a curved bottom surface formed by the inter-terminal wall 12e of the first protrusion 12 which is part of the first housing 11, and both side surfaces formed by the adjacent first terminals 61, specifically the outer column part 63 and the inner column part 65. In addition, the widthwise dimension (X-axis direction) of the recessed part 12d is set to approximately 0.065 mm, which is narrower than the proximal contact protrusion 166a of the proximal contact part 166 and the distal contact protrusion 165a of the distal contact part 165 on the contact part 167 of the second terminal 161. Note that the widthwise (X-axis direction) dimension of the proximal contact protrusion 166a of the proximal contact part 166 and the distal contact protrusion 165a of the distal contact part 165 of the second terminal 161 is set to approximately 0.080 mm, which is narrower than the second contact surface 63a of the outer column part 63 of the first terminal 61 and the first contact surface 65a of the inner column part 65, but wider than the recessed part 12d.

In this manner, the distance between adjacent first terminals 61 is narrower than the width of the second terminals 161; more preferably, the widthwise dimension of the recessed part 12d formed in the inter-terminal wall 12e between adjacent first terminals 61 is smaller than the widthwise dimension of the proximal contact protrusion 166a of the proximal contact part 166 and the distal contact protrusion 165a of the distal contact part 165 of the second terminal 161. Therefore, when the first connector 1 and the second connector 101 are in a mated state, even if an excessive load in the longitudinal direction (X-axis direction) is applied to the first connector 1 and/or the second connector 101 for some reason (for example, an electronic device on which the connector assembly is mounted is dropped to the floor or another member collides with the electronic device, causing a large external force to be applied), the second terminal 161 will not fall into the recessed part 12d, and the first terminal 61 and/or the second terminal 161 will not be damaged. Furthermore, when the excessive load is released, the relative positional relationship between the first connector 1 and the second connector 101, and the relative positional relationship between the first terminal 61 and the second terminal 161 may return to the original state as depicted in FIGS. 14 and 15. Therefore, the reliability of the connection may be maintained.

For example, when the first connector 1 and the second connector 101 are in a mated state, if excessive load in the longitudinal direction is applied to the first connector 1 and/or the second connector 101, the relative positions of the first connector 1 and the second connector 101 may become offset in the longitudinal direction (X-axis direction), as depicted in FIG. 16. In this case, as depicted in FIG. 17, the proximal contact protrusion 166a of the proximal contact part 166 and the distal contact protrusion 165a of the distal contact part 165 in the contact part 167 of the second terminal 161 are offset relatively in position in the longitudinal direction (X-axis direction) of the first connector 1 and the second connector 101 from the second contact surface 63a of the outer column part 63 and the first contact surface 65a of the inner column part 65 of the first terminal 61, and are facing the recessed part 12d formed in the inter-terminal wall 12e between the first terminals 61. However, since the widthwise dimension of the recessed part 12d is smaller than the widthwise dimension of the proximal contact protrusion 166a of the proximal contact part 166 of the second terminal 161 and the distal contact protrusion 165a of the distal contact part 165, the proximal contact protrusion 166a of the proximal contact part 166 and the distal contact protrusion 165a of the distal contact part 165 of the second terminal 161 do not fall into the recessed part 12d.

For comparison, a reference example depicted in FIGS. 18 to 21 will now be described. The connector assembly in this reference example has a configuration that is almost the same as that of the connector assembly in the present embodiment, and therefore the symbols assigned to each part thereof will be described using the symbols assigned to each part of the connector assembly in the present embodiment with an apostrophe added. The parts of the connector assembly in the present embodiment, which use symbols without an apostrophe, and the parts of the connector assembly in the reference example, which use symbols with an apostrophe added, will be described as being approximately the same.

As depicted in FIGS. 18 and 19, when the mating of the first connector 1' and the second connector 101' is completed and the first terminal 61' and the second terminal 161' are electrically connected, the proximal contact protrusion 166a' of the proximal contact part 166' and the distal contact protrusion 165a' of the distal contact part 165' of each second terminal 161' come into contact with the second contact surface 63a' of the outer column part 63' and the first contact surface 65a' of the inner column part 65' of the corresponding first terminal 61'. Furthermore, recessed parts 12d' are formed in the inter-terminal walls 12e' between the first terminals 61' adjacent to each other in the longitudinal direction (X-axis direction) of the first connector 1'.

The dimension of the recessed part 12d' in the width direction (X-axis direction) is set to approximately 0.068 mm. In addition, the widthwise (X-axis direction) dimension of the proximal contact protrusion 166a' of the proximal contact part 166' and the distal contact protrusion 165a' of the distal contact part 165' of the second terminal 161' is set to approximately 0.060 mm. In other words, in the reference example, the width of the recessed part 12d' formed between adjacent first terminals 61' is wider than the width of the proximal contact protrusion 166a' of the proximal contact part 166' and the distal contact protrusion 165a' of the distal contact part 165' of the second terminal 161'.

Therefore, as depicted in FIGS. 20 and 21, when excessive load in the longitudinal direction is applied to the first connector 1' and/or the second connector 101', the relative positions of the first connector 1' and the second connector 101' are offset in the longitudinal direction (X-axis direction), and the proximal contact protrusion 166a' of the proximal contact part 166' and the distal contact protrusion 165a' of the distal contact part 165' of the second terminal 161' are offset relatively in the longitudinal direction (X-axis direction) of the first connector 1' and the second connector 101' from the second contact surface 63a' of the outer column part 63' and the first contact surface 65a' of the inner column part 65' of the first terminal 61', and face the recessed part 12d' formed in the inter-terminal wall 12e' between the first terminals 61'. Furthermore, in the reference example, the widthwise dimension of the recessed part 12d' is larger than the widthwise dimension of the proximal contact protrusion 166a' of the proximal contact part 166' and the distal contact protrusion 165a' of the distal contact part 165' of the second terminal 161', so the proximal contact protrusion 166a' of the proximal contact part 166' and the distal contact protrusion 165a' of the distal contact part 165' of the second terminal 161' fall into the recessed part 12d'.

Thus, in the present embodiment, the connector assembly includes the second connector 101 and the first connector 1 that mates with the second connector 101. Furthermore, the second connector 101 includes a second housing 111 and a second terminal 161 attached to the second housing 111, the second housing 111 including a housing wall part 111e positioned between the main body part 163 and the contact part 167 of the second terminal 161, and the first connector 1 includes a first housing 11 and a first terminal 61 attached to the first housing 11, the first housing 11 including a flange 17a formed on at least a first outer edge of the side wall part 18 on which the first terminal 61 is mounted, and when the second connector 101 and the first connector 1 are in a mated state, an area more than half (50%) of the upper surface 17a1 of the flange 17a may abut against the upper wall surface 111a of at least a first housing wall part 111e of the second housing 111.

As a result, even if an excessive load directed in the mating direction is applied to the first connector 1 and/or the second connector 101 for some reason while the second connector 101 and the first connector 1 are in a mated state, stability of the mated state between the first connector 1 and the second connector 101 is maintained. Accordingly, narrowing of width or reduction in height does not cause damage to the first connector 1 and/or the second connector 101, and narrowing of width or reduction in height also does not cause the first connector 1 and the second connector 101 to become relatively inclined, thereby enabling maintenance of mating reliability. Therefore, it is possible to provide a connector assembly that is easy to manufacture, can be made smaller and thinner, and is highly reliable.

In addition, the contact part 167 of the second terminal 161 includes a distal contact part 165, a proximal contact part 166, and a distal connection part 164 that connects the distal contact part 165 and the proximal contact part 166, and has an overall approximately U-shaped configuration, and the upper wall surface 111a of the housing wall part 111e is formed up to an overhang part 111d that covers an upper part of the proximal contact part 166 positioned on the main body part 163 side of the second terminal 161. Furthermore, a tail part 162 is formed at the lower end of the main body part 163 of the second terminal 161. Furthermore, the second terminal 161 includes a proximal connection part 163b that connects the main body part 163 and the proximal contact part 166, and the lower end of the housing wall part 111e faces the proximal connection part 163b with a gap therebetween. Furthermore, the lower surface 17a2 of the flange 17a of the first housing 11 is positioned closer to the mating surface than the lower surface 17c of the bottom plate part 17 of the first housing 11.

Next, Embodiment 2 will be described. It should be noted that a description is omitted for parts having the same structure as those of Embodiment 1 by assigning the same reference numbers. Moreover, descriptions of the same operations and effects as those of Embodiment 1 will be omitted.

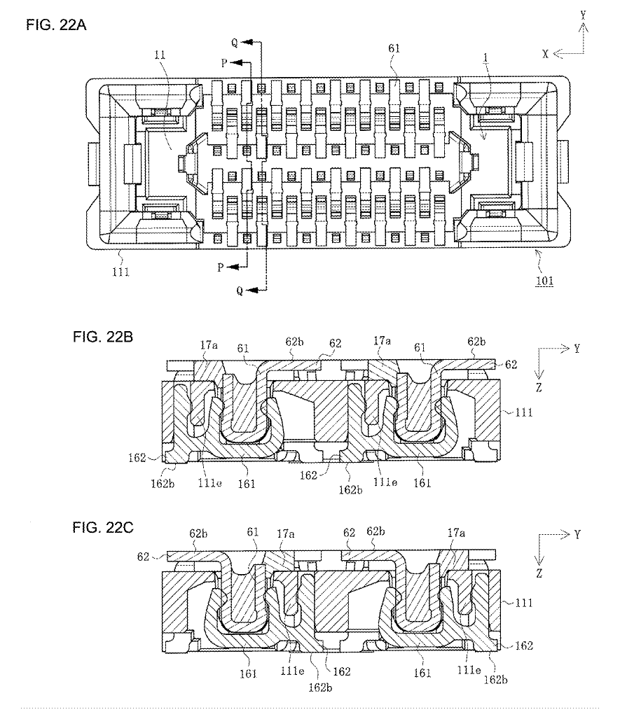

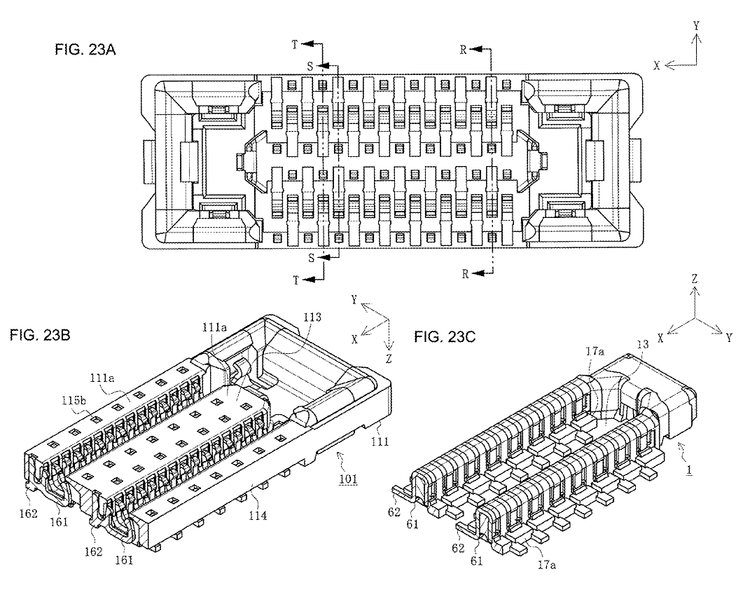

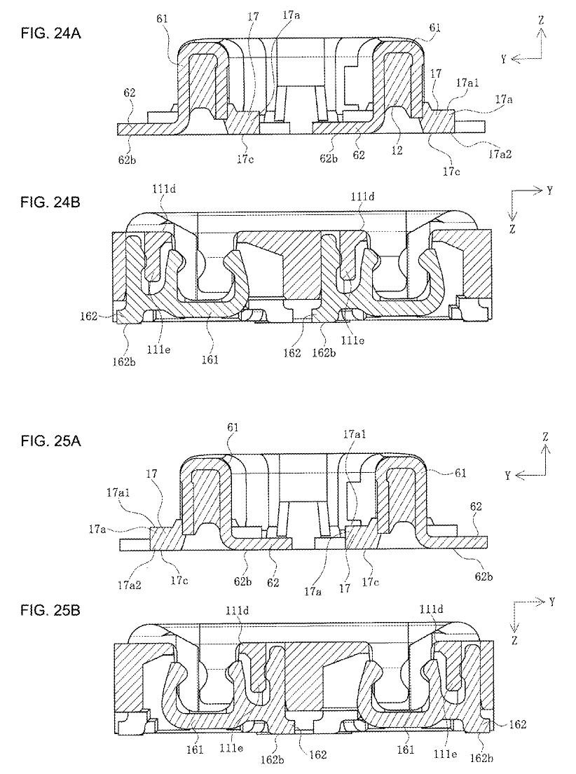

FIG. 22 is a first three-plane diagram depicting the first connector and the second connector according to Embodiment 2 in a mated state. FIG. 23 is a second three-plane diagram depicting the first connector and the second connector according to Embodiment 2 in a mated state. FIG. 24 is a first transverse cross-sectional view of the first connector and the second connector according to Embodiment 2 in a mated state. FIG. 25 is a second transverse cross-sectional view of the first connector and the second connector according to Embodiment 2 in a mated state. Note that FIG. 22A is a plan view of the first connector as viewed from the side, FIG. 22B is a cross-sectional view along line P-P in FIG. 22A, and FIG. 22C is a cross-sectional view along line Q-Q in FIG. 22A. FIG. 23A is a plan view of the first connector from the side, FIG. 23B is a perspective view of the second connector including a cross section along line R-R in FIG. 23A, and FIG. 23C is a perspective view of the first connector including a cross section along line R-R in FIG. 23A. FIG. 24A is a cross-sectional view of the first connector along line S-S in FIG. 23A, and FIG. 24B is a cross-sectional view of the second connector along line S-S in FIG. 23A. FIG. 25A is a cross-sectional view of the first connector along line T-T in FIG. 23A, and FIG. 25B is a cross-sectional view of the second connector along line T-T in FIG. 23A.

In Embodiment 1, an example was described in which the tail part 62 of the first terminal 61 extends inward in the width direction (Y-axis direction) of the first connector 1, in other words, extends into the recessed groove part 13, and the length of the tail part 62 and the lower surface 62b thereof is shorter than that of the first terminal 61 having a tail part 62 extending outward in the width direction (Y-axis direction) of the first connector 1. However, in the present embodiment, the first terminal 61 with the tail part 62 extending inward in the width direction of the first connector 1 and the first terminal 61 with the tail part 62 extending outward in the width direction of the first connector 1 are formed so that the lengths of the tail parts 62 and the lower surfaces 62b thereof are equal. Note that with regard to the portions other than the tail part 62, in both Embodiment 1 and in the present embodiment, the first terminals 61 extending toward the inside of the first connector 1 in the width direction and the first terminals 61 extending toward the outside of the first connector 1 in the width direction have the same shape and dimensions.

In other words, in the present embodiment, all of the first terminals 61 have the same shape and dimensions.

Therefore, in the present embodiment, the first terminal 61 can be easily manufactured, and the manufacturing cost can be reduced. In addition, since the configuration of the first connector 1 including the first terminals 61 is simplified, the manufacturing of the first connector 1 becomes easier, and the manufacturing costs can be reduced.

In addition, in Embodiment 1, an example was described in which, in the second terminal 161 where the tail part 162 thereof extends inward in the width direction (Y-axis direction) of the second connector 101, the protruding length of the tail part 162 from the lower end of the main body part 163 is shorter than in the second terminal 161 where the tail part 162 thereof extends outward in the width direction (Y-axis direction) of the second connector 101, and the lower surface 162b of the tail part 162 is formed closer to the proximal contact part 166. However, in the present embodiment, the second terminal 161 where tail part 162 thereof extends inward in the width direction of the second connector 101 and the second terminal 161 where the tail part 162 thereof extends outward in the width direction of the second connector 101 are formed so that the protruding length of the tail part 162 from the lower end of the main body part 163 is the same, and the distance of the lower surface 162b from the proximal contact part 166 is also the same. Note that in addition, with respect to the portions other than the tail part 162, in both Embodiment 1 and the present embodiment, the second terminals 161 extending toward the inside of the second connector 101 in the width direction and the second terminals 161 extending toward the outside of the second connector 101 in the width direction have the same shape and dimensions.

In other words, in the present embodiment, all of the second terminals 161 have the same shape and dimensions.

Therefore, in the present embodiment, the second terminal 161 can be easily manufactured, and the manufacturing cost can be reduced. Furthermore, since the configuration of the second connector 101 including second terminal 161 is simplified, manufacturing of second connector 101 becomes easier, and the manufacturing cost can be reduced.

Furthermore, in Embodiment 1, an example was described in which the flange 17a of the first housing 11 is formed only on the outer surface 12b side of the bottom plate part 17, and not on the inner surface 12c side of the bottom plate part 17, and furthermore, the flange 17a is formed so as to be positioned higher (Z-axis positive direction) than the lower surface 17c of the bottom plate part 17, and the lower surface 17a2 (the surface on the mounting surface side) of the flange 17a is positioned higher (Z-axis positive direction) than the lower surface 17c of the bottom plate part 17. However, in the present embodiment, the flange 17a is formed on the outer surface 12b side and the inner surface 12c side of the bottom plate part 17, and furthermore, the lower surface 17a2 of the flange 17a is formed so as to be flush with the lower surface 17c of the bottom plate part 17.

As a result, when the first connector 1 and the second connector 101 are mated completely, the upper wall surface 111a of the second protrusion 113 of the second housing 111 and the upper wall surface 111a of the side wall part 114, in other words, the upper wall surface 111a of the housing wall part 111e on both sides of the width of the second housing 111, may abut against the upper surface 17a1 of the flange 17a of the first housing 11.

Therefore, in the present embodiment, the range over which the upper surface 17a1 of the flange 17a and the upper wall surface 111a of the housing wall part 111e may abut is extremely wide, so that even if excessive load is applied to the first connector 1 and/or the second connector 101 in the mating direction, the stability of the mated state between the first connector 1 and the second connector 101 is more reliably maintained, and the first connector 1 and/or the second connector 101 will not be damaged or the first connector 1 and the second connector 101 will not tilt relative to each other, thereby maintaining higher mating reliability.

Note that other components of the first connector 1 in the present embodiment are the same as those in Embodiment 1, and thus, description thereof is omitted. In addition, the configuration of the second connector 101 in the present embodiment is also similar to that of Embodiment 1, and therefore a description thereof will be omitted. Furthermore, other basic configurations and effects in which the first connector 1 and the second connector 101 are in a mated state are also similar to those of Embodiment 1, and therefore description thereof will be omitted.

In this manner, in the present embodiment, when the second connector 101 and the first connector 1 are in a mated state, more than half of the upper surface 17a1 of the flange 17a may abut against the upper wall surfaces 111a of both housing wall parts 111e of the second housing 111.

As a result, even if an excessive load directed in the mating direction is applied to the first connector 1 and/or the second connector 101 for some reason while the second connector 101 and the first connector 1 are in a mated state, stability of the mated state between the first connector 1 and the second connector 101 is more reliably maintained. Accordingly, the first connector 1 and/or the second connector 101 are not damaged, and the first connector 1 and the second connector 101 do not become relatively inclined, thereby enabling maintenance of higher mating reliability.

Next, Embodiment 3 will be described. It should be noted that a description is omitted for parts having the same structure as those of Embodiments 1 and 2 by assigning the same reference numbers. Moreover, descriptions of the same operations and effects as those of Embodiments 1 and 2 will be omitted.

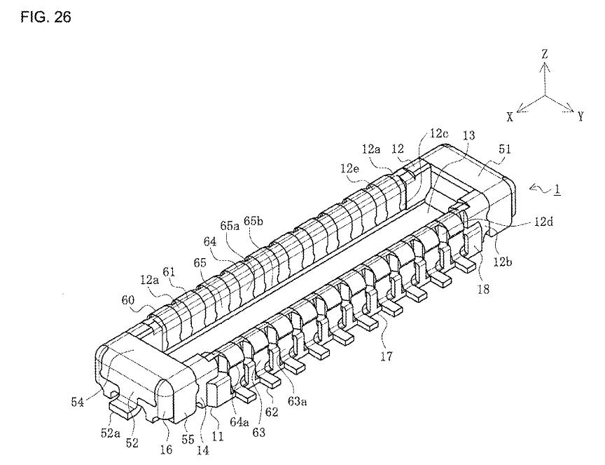

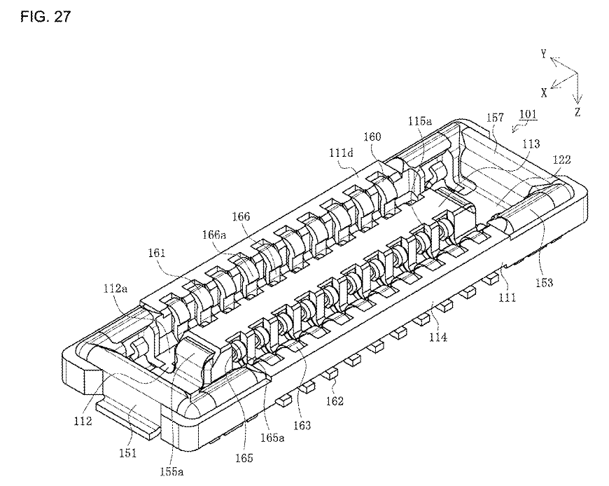

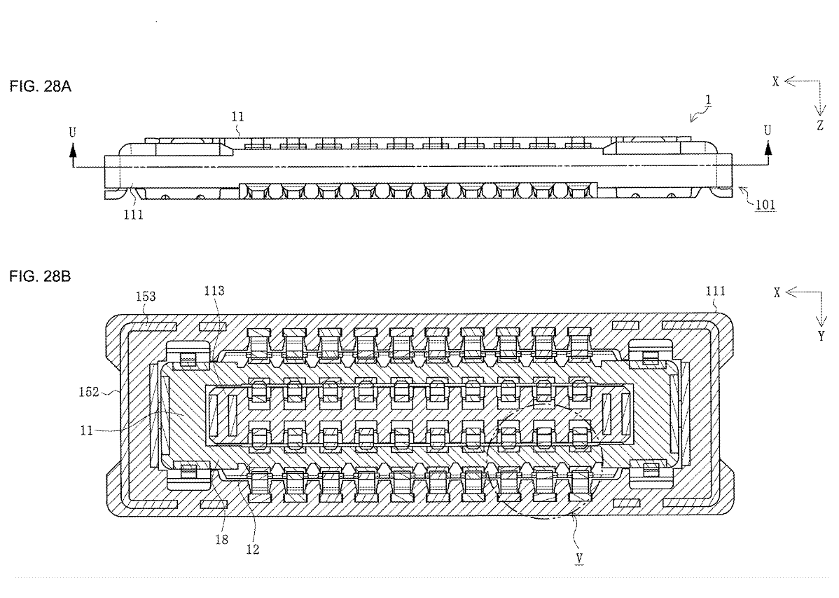

FIG. 26 is a perspective view of the first connector according to Embodiment 3. FIG. 27 is a perspective view of the second connector according to Embodiment 3.

In Embodiments 1 and 2, examples were described in which adjacent first terminals 61 in each terminal row 60 of the first connector 1 are arranged so that they face opposite sides to each other when viewed in the longitudinal direction (X-axis direction) of the first connector 1. However, in the present embodiment, as depicted in FIG. 26, all first terminals 61 in each terminal row 60 face the same direction. Note that the first terminals 61 of the right terminal row 60 and the first terminals 61 of the left terminal row 60 are oriented in opposite directions. Therefore, while the tail parts 62 of the first terminals 61 are arranged in four rows overall and in a staggered pattern in Embodiments 1 and 2, in the present embodiment they are arranged in two rows overall and in a straight line.

In addition, in the first terminal 61 in Embodiments 1 and 2, an example was described in which the upper end protrusion 64a is formed at the boundary between the upper end of the inner column part 65 and the connecting part 64, but in the first terminal 61 in the present embodiment, the upper end protrusion 64a is formed at the boundary between the upper end of the outer column part 63 and the connecting part 64.

Furthermore, in Embodiments 1 and 2, examples were described in which the second terminal 161 was a member integrally formed by subjecting a conductive metal plate to processing such as punching, but in the present embodiment, the second terminal 161 is a member integrally formed by subjecting a conductive metal plate to processing such as punching and bending, and is equipped with a main body part 163 as a press-fit portion, a tail part 162 connected to the lower end of the main body part 163, a proximal contact part 166 connected to the upper end of the main body part 163, a distal connection part 164 (not depicted) extending from the lower end of the proximal contact part 166 in the width direction of the second connector 101, and a distal contact part 165 extending upward (Z-axis negative direction) from the tip end of the distal connection part 164. Note that the proximal connection part 163b is omitted.

In addition, in Embodiments 1 and 2, examples have been described in which adjacent second terminals 161 in each terminal row 160 of the second connector 101 are arranged so that they face opposite sides to each other when viewed from the longitudinal direction (X-axis direction) of the second connector 101, but in the present embodiment, as depicted in FIG. 27, all second terminals 161 in each terminal row 160 face the same direction. Note that the second terminals 161 of the right terminal row 160 and the second terminals 161 of the left terminal row 160 are oriented in opposite directions. Therefore, while the tail parts 162 of the second terminals 161 are arranged in four rows overall and in a staggered pattern in Embodiments 1 and 2, in the present embodiment they are arranged in two rows overall and in a straight line.

Note that the other configurations of the first connector 1 and the second connector 101 in the present embodiment are generally similar to those in Embodiments 1 and 2, and therefore a description thereof will be omitted.

Next, a state in which the first connector 1 and the second connector 101 having the above-described configuration have been mated together will be described.

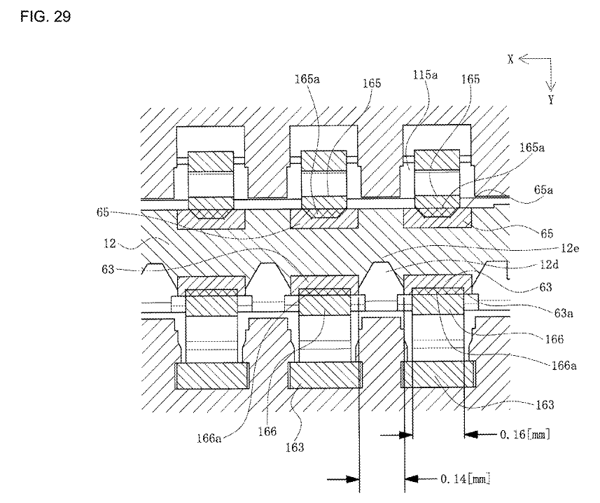

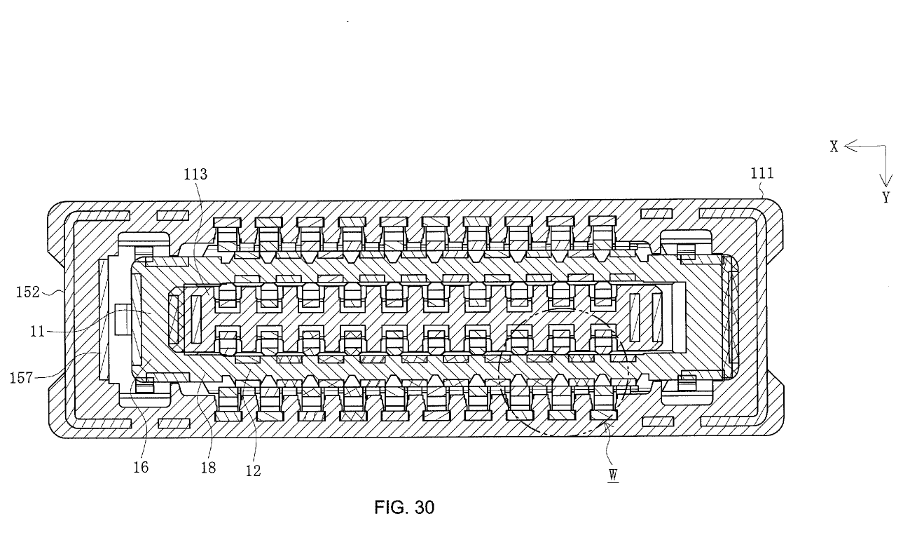

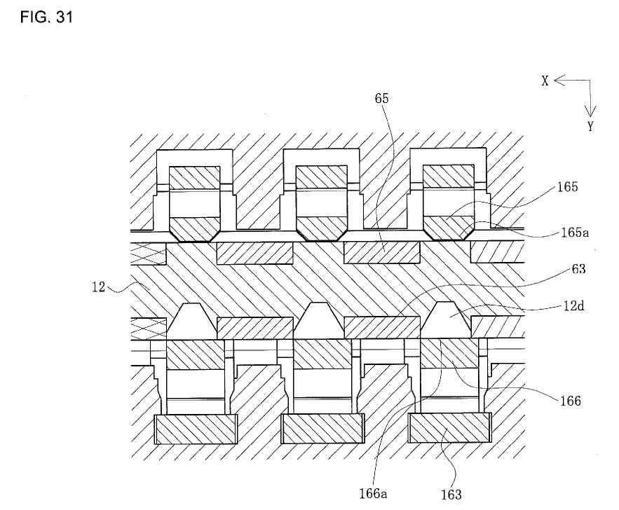

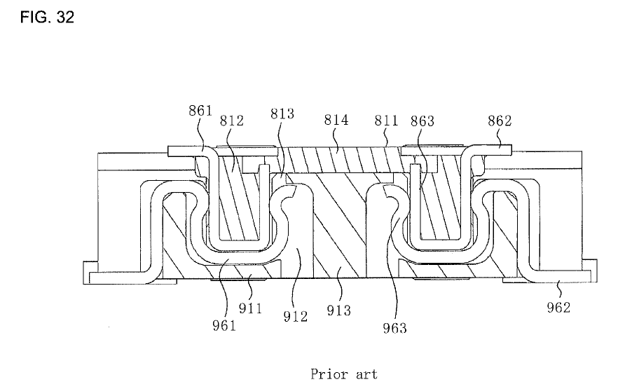

FIG. 28 is a two-plane diagram depicting the first connector and the second connector according to Embodiment 3 in a mated state. FIG. 29 is an enlarged cross-sectional view of the first connector and the second connector according to Embodiment 3 in a mated state, and is an enlarged view of part V in FIG. 28B. FIG. 30 is a cross-sectional view depicting a case where the relative positions of the first connector and the second connector in a mated state according to Embodiment 3 are offset, and is a cross-sectional view corresponding to the cross section along U-U in FIG. 28A. FIG. 31 is an enlarged cross-sectional view of a case where the relative positions of the first connector and the second connector in the mated state according to Embodiment 3 are offset, and is an enlarged view of part W in FIG. 30. Note that in FIG. 28, FIG. 28A is a side view, and FIG. 28B is a cross-sectional view taken along the line U-U in FIG. 28A.

The operation of mating the first connector 1 and the second connector 101 in the present embodiment is the same as in Embodiments 1 and 2, and therefore a description thereof will be omitted.

In the present embodiment, when the mating of the first connector 1 and the second connector 101 is completed and the first terminal 61 and the second terminal 161 are electrically connected, as depicted in FIGS. 28B and 29, the proximal contact protrusion 166a of the proximal contact part 166 of each second terminal 161 and the distal contact protrusion 165a of the distal contact part 165 come into contact with the second contact surface 63a of the outer column part 63 and the first contact surface 65a of the inner column part 65, which are the contact surfaces of the corresponding first terminal 61. Note that in addition, with respect to the longitudinal direction (X-axis direction) of the first connector 1, a recessed part 12d is formed in the inter-terminal wall 12e between adjacent first terminals 61 on the outer surface 12b side, and is indented toward the center of the first protrusion 12 in the thickness direction (Y-axis direction). In the present embodiment, the inter-terminal wall 12e on the inner surface 12c side does not have the recessed part 12d formed therein.

The recessed part 12d in the example depicted in the figure is a groove-shaped recessed indent part having a roughly U-shaped cross-section in cross section (X-axis-Y-axis cross section), with a roughly curved bottom surface formed by the inter-terminal wall 12e of the first protrusion 12 which is part of the first housing 11, and both side surfaces formed between adjacent first terminals 61, specifically, between the outer column parts 63. In addition, the widthwise dimension (X-axis direction) of the recessed part 12d is set to approximately 0.14 mm, which is narrower than the proximal contact protrusion 166a of the proximal contact part 166 in the contact part 167 of the second terminal 161. Note that the widthwise (X-axis direction) dimension of the proximal contact protrusion 166a of the proximal contact part 166 of the second terminal 161 is set to approximately 0.16 mm, which is narrower than the second contact surface 63a of the outer column part 63 of the first terminal 61 but wider than the recessed part 12d.

In this manner, the distance between adjacent first terminals 61 is narrower than the width of the second terminals 161; more preferably, the widthwise dimension of the recessed part 12d formed in the inter-terminal wall 12e between adjacent first terminals 61 on the outer surface 12b is smaller than the widthwise dimension of the proximal contact protrusion 166a of the proximal contact part 166 of the second terminal 161. Therefore, when the first connector 1 and the second connector 101 are in a mated state, even if an excessive load in the longitudinal direction (X-axis direction) is applied to the first connector 1 and/or the second connector 101 for some reason (for example, an electronic device on which the connector assembly is mounted is dropped to the floor or another member collides with the electronic device, thereby applying a large external force), the second terminal 161 will not fall into the recessed part 12d, and the first terminal 61 and/or the second terminal 161 will not be damaged. Furthermore, when the excessive load is released, the relative positional relationship between the first connector 1 and the second connector 101, and the relative positional relationship between the first terminal 61 and the second terminal 161 are able to return to the original state as depicted in FIGS. 28 and 29. Therefore, the reliability of the connection can be maintained.

For example, when the first connector 1 and the second connector 101 are in a mated state, if excessive load in the longitudinal direction is applied to the first connector 1 and/or the second connector 101, the relative positions of the first connector 1 and the second connector 101 may become offset in the longitudinal direction (X-axis direction), as depicted in FIG. 30. In this case, as depicted in FIG. 31, the proximal contact protrusion 166a of the proximal contact part 166 and the distal contact protrusion 165a of the distal contact part 165 at the contact part 167 of the second terminal 161 are relatively shifted in position in the longitudinal direction (X-axis direction) of the first connector 1 and the second connector 101 from the second contact surface 63a of the outer column part 63 and the first contact surface 65a of the inner column part 65 of the first terminal 61, and the proximal contact protrusion 166a of the proximal contact part 166 is positioned opposite the recessed part 12d formed in the inter-terminal wall 12e between the first terminals 61 on the outer surface 12b. However, since the widthwise dimension of the recessed part 12d is smaller than the widthwise dimension of the proximal contact protrusion 166a of the proximal contact part 166 of the second terminal 161, the proximal contact protrusion 166a of the proximal contact part 166 of the second terminal 161 does not fall into the recessed part 12d.

Note that the disclosure herein describes features relating to suitable exemplary embodiments. Various other embodiments, modifications, and variations within the scope and spirit of the patent claims appended hereto will naturally be conceived of by a person of ordinary skill in the art upon review of the specification herein.

1. A connector assembly comprising:
a receptacle connector comprising a receptacle housing and a receptacle terminal attached to the receptacle housing, the receptacle terminal including a press-fit part and a contact part, the receptacle housing including a housing wall part positioned between the press-fit part and the contact part; and
a plug connector mated with the receptacle connector, the plug connector comprising a plug housing and a plug terminal attached to the plug housing, the plug housing including a flange formed on at least an outer edge of an area in which the plug terminal is mounted, and
wherein more than half of an upper surface of the flange is configured to abut against an upper wall surface of the housing wall part of the receptacle housing when the receptacle connector and the plug connector are in a mated state.

2. The connector assembly according to claim 1, wherein the housing wall part defines a first housing wall part and the receptacle housing further includes a second housing wall part having an upper wall surface, and wherein more than half of the upper surface of the flange is configured to abut against the upper wall surfaces of both housing wall parts of the receptacle housing when the receptacle connector and the plug connector are in the mated state.

3. The connector assembly according to claim 1, wherein the contact part of the receptacle terminal includes a first arm part, a second arm part, and a connecting part that connects the first arm part and the second arm part, and has an overall approximately U-shaped configuration, and the upper wall surface of the housing wall part is formed up to an area that covers an upper part of the second arm part positioned on a side of the press-fit part of the receptacle terminal.

4. The connector assembly according to claim 3, wherein the receptacle terminal includes a second connecting part connecting the press-fit part and the second arm part, and a lower end of the housing wall part faces the second connecting part with a gap therebetween.

5. The connector assembly according to claim 1, wherein a board connection part is formed at a lower end of the press-fit part of the receptacle terminal.

6. The connector assembly according to claim 1, wherein the plug terminal includes an inner column part, and the upper surface of the flange of the plug housing includes an inner column lower cover part that covers at least a part of a lower end of the inner column part of the plug terminal.
